(19) United States
(12) Patent Application Publication
(10) Pub. No.: US 2015/0331551 A1
(43) Pub. Date: Nov. 19, 2015

(54) IMAGE DISPLAY APPARATUS, IMAGE DISPLAY METHOD, AND COMPUTER-READABLE RECORDING MEDIUM

(71) Applicant: Samsung Electronics Co., Ltd., Suwon-si (KR)

(72) Inventors: Keum-koo LEE, Yongin-si (KR); Yoon-su KIM, Seoul (KR); Jung-joo SOHN, Seoul (KR); Eun-mee SHIN, Yongin-si (KR); Young-kyu JIN, Seoul (KR)

(21) Appl. No.: 14/712,322

(22) Filed: May 14, 2015

Related U.S. Application Data
(60) Provisional application No. 61/996,652, filed on May 14, 2014.

(30) Foreign Application Priority Data
Nov. 27, 2014 (KR) 10-2014-0167709

(51) Int. Cl. G06F 3/0481; G06F 3/0484

(52) U.S. Cl. CPC G06F 3/0481; G06F 3/0484; G06F 3/04817

(57) ABSTRACT

An image display method, an image display apparatus, and a non-transitory computer-readable storage medium are provided. The image display method includes displaying a first image in a screen of the image display apparatus, and displaying a second image including information related to the first image in one region of the screen in response to a first user command being input, wherein the information related to the first image is acquired using a user-based program stored in the image display apparatus in connection with metadata of the first image.

### CROSS-REFERENCE TO RELATED APPLICATION(S)

This application claims the benefit under 35 U.S.C. §119(e) of a U.S. Provisional application filed on May 14, 2014 in the U.S. Patent and Trademark Office and assigned Ser. No. 61/996,652, and under 35 U.S.C. §119(a) of a Korean patent application filed on Nov. 27, 2014 in the Korean Intellectual Property Office and assigned Serial number 10-2014-0167709, the entire disclosure of each of which is hereby incorporated by reference.

### TECHNICAL FIELD

The present disclosure relates to an image display apparatus, an image display method, and a computer-readable recording medium. More particularly, the present disclosure relates to an image display apparatus, an image display method, and a computer-readable recording medium, in which information related to an image currently displayed on a screen is easily received using a user-based stored program in the image display apparatus such as a digital television (DTV) and the information is viewed.

### BACKGROUND

In recent years, with the use of smart apparatuses (e.g., a smartphone, a smart television, etc.,), which are different from previous (e.g., non-smart) apparatuses in which an arbitrary service, application, or function is limited in individual apparatus units and consumed, there is a tendency for a user to select and use specific service such as a broadcasting program, an application, and a function in a unit.

However, most of users who use smartphones feel tiredness due to the efforts according to free selection, and it is further difficult to expect the aggressive selection behavior in a passive apparatus such as a television (TV).

Further, the users have to execute a corresponding application to check specific content or a function, and thus a cut-off in viewing flow is caused due to an occurrence of screen convention.

In response to a preview of a widget type being provided, an amount of content is considerably restricted due to the limitation of space.

Thus, a structure, which can be personalized in view units, and user patterns optimized to a smart TV, such as glancing through a preview, multitasking, or task-shifting through a screen element of a partial view type, are needed.

For example, the need for registering a desired screen such as a frequently used application, content source, and channel to a personalized panel, that is, a user apparatus, calling a corresponding screen in any situation, and using the screen by the user is raised.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an image display apparatus, an image display method, and a non-transitory computer-readable storage medium, in which information related to an image currently displayed in a screen is easily received using a user-based stored program in the image display apparatus such as a digital television (DTV) and the information is viewed.

In accordance with an aspect of the present disclosure, a method of displaying an image is provided. The method includes displaying a first image in a screen of an image display apparatus and displaying a second image including information related to the first image in one region of the screen in response to a first user command being input, wherein the information related to the first image may be acquired using a user-based program stored in the image display apparatus in connection with metadata of the first image.

In accordance with an aspect of the present disclosure, the displaying of the first image may include displaying the first image in a full screen of the image display apparatus, the displaying of the first image may include displaying the first image in a first region into which the full screen is divided in response to the first user command being input, and the displaying of the second image related to the first image on the one region of the screen may include displaying the second image in a second region into which the full screen is divided.

In accordance with an aspect of the present disclosure, the second image may include information associated with a plurality of pieces of key data designated among the metadata, and the information associated with the plurality of pieces of key data may be provided differently according to a user based on the user-based program.

In accordance with an aspect of the present disclosure, the method may further include displaying the first image together with a third image including watchable information of the user selected based on a viewing pattern of the user in response to a second user command being input, and the watchable information may include channeling information related to an auto channeling function which changes the first image to an image based on the viewing pattern.

In accordance with an aspect of the present disclosure, the method may further include, in response to a third user command being input, displaying the first image in the divided first region of the screen, and displaying a fourth image for representing a designated information object in a form of an icon and a fifth image for representing a context and information of a new image screen matching with the icon in the divided second region of the screen.

In accordance with an aspect of the present disclosure, the fourth image may allow an information object desired by a user among information objects having information-structural depths to be registered in a form of the icon.

In accordance with an aspect of the present disclosure, a new fourth image for representing an information object designated by an arbitrary user in an icon form may be displayed in response to a user account-related icon being selected in the fourth image.

In accordance with an aspect of the present disclosure, the method may further include changing the first image to an image based on a viewing pattern of a user, and displaying the changed image in response to an auto channeling function for automatically changing the image based on the viewing pattern of the user being set.

In accordance with an aspect of the present disclosure, the first image may be analyzed and a result of the analysis may be used as the metadata, in response to the metadata being provided from an outside in connection with the first image being not presented.

In accordance with another aspect of the present disclosure, an image display apparatus for displaying an image is provided. The image display apparatus includes a display unit configured to display a received first image in a screen and a controller configured to control the display unit to display a second image including information related to the first image in one region of the screen in response to a first user command being input, wherein the information related to the first image may be acquired using a user-based program stored in the image display apparatus in connection with metadata of the first image.

In accordance with an aspect of the present disclosure, the display unit may be further configured to display the first image in a full screen of the image display apparatus, display the first image in a first region into which the full screen is divided, and display the second image in a second region into which the full screen is divided in response to the first user command being input.

In accordance with an aspect of the present disclosure, the display unit may be further configured to display information associated with a plurality of pieces of key data designated among the metadata in the second image, wherein the information associated with the plurality of pieces of key data may be differently provided according to the user based on the user-based program.

In accordance with an aspect of the present disclosure, the display unit may be further configured to display the first image together with a third image including watchable information of a user selected based on a viewing pattern of the user in response to a second user command being input, wherein the watchable information may include channeling information related to an auto channeling function which changes the first image to an image based on the viewing pattern.

In accordance with an aspect of the present disclosure, the display unit may, in response to a third user command being input, be further configured to display the first image into the divided first region of the screen, and display a fourth image for representing a designated information object in a form of an icon and a fifth image for representing a context and information of a new image screen matching with the icon in the divided second region of the screen.

In accordance with an aspect of the present disclosure, the fourth image may allow an information object desired by a user among information objects having information-structural depths to be registered in a form of the icon.

In accordance with an aspect of the present disclosure, the display unit may be further configured to display a new fourth image for representing an information object designated by an arbitrary user in an icon form in response to a user account-related icon being selected in the fourth image.

In accordance with an aspect of the present disclosure, the controller may be further configured to change the first image to an image based on a viewing pattern of a user in response to an auto channeling function for automatically changing the image based on the viewing pattern of the user being set.

In accordance with an aspect of the present disclosure, the controller may be further configured to analyze the first image and use a result of the analysis as the metadata, in response to the metadata being provided from an outside in connection with the first image being not presented.

In accordance with another aspect of the present disclosure, a non-transitory computer-readable storage medium storing instructions, that, when executed, cause at least one processor to perform an image display method is included. The image display method includes displaying a second image including information related to a first image displayed in a screen in one region of the screen in response to a first user command being input, and displaying the first image and a third image including watchable information of a user selected based on a viewing pattern of the user in response to a second user command being input, wherein the information related to the first image may be acquired using a user-based program stored in an image display apparatus in connection with metadata of the first image.

In accordance with an aspect of the present disclosure, the watchable information may include channeling information related to an auto channeling function which changes the first image to an image based on the viewing pattern, wherein, in response to a third user command being input, the image display method may further comprise displaying the first image in a divided first region of the screen, and displaying a fourth image for representing a designated information object in a form of an icon and a fifth image for representing a context and information of a new image screen matching with the icon in a divided second region of the screen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a user-based screen providing service system according to an embodiment of the present disclosure;

FIG. 2 is a view illustrating schematics of various types of views displayed in an image display apparatus of FIG. 1 in one screen according to an embodiment of the present disclosure;

FIGS. 3A, 3B, and 3C are detailed views illustrating a realization state for various types of views according to a user command according to various embodiments of the present disclosure;

FIG. 4 is a block diagram illustrating a structure of an image display apparatus illustrated in FIG. 1 according to an embodiment of the present disclosure;

FIG. 5 is a block diagram illustrating a structure of an image display apparatus illustrated in FIG. 1 according to an embodiment of the present disclosure;

FIG. 6 is a view explaining a screen conversion of a home view region and a dynamic view region of FIG. 2 according to an embodiment of the present disclosure;

FIG. 7A is a view explaining a process of registering an information object through matching with an execution icon of a home view region regardless of an information level according to an embodiment of the present disclosure;

FIG. 7B is a view explaining a concept of a view level according to an application and a screen list according to an embodiment of the present disclosure;

FIG. 8 is a view explaining a dynamic view region of FIG. 2 according to an embodiment of the present disclosure;

FIG. 9 is a view illustrating an example of generating a dynamic view region illustrated in FIG. 8 according to an embodiment of the present disclosure;

FIG. 10 is a view explaining a contextual view region of FIG. 2 according to an embodiment of the present disclosure;

FIGS. 11A and 11B are views explaining a process of generating various pieces of information displayed in a contextual view region according to various embodiments of the present disclosure;

FIGS. 12A, 12B, 12C, 12D, 12E, and 12F are views illustrating various pieces of information displayed in a contextual view region according to various embodiments of the present disclosure.

FIGS. 13A and 13B are views explaining a banner view region of FIG. 2 according to various embodiments of the present disclosure;

FIGS. 14A, 14B, and 14C are views explaining watching reservation information displayed in a banner view region of FIG. 2 according to various embodiments of the present disclosure;

FIG. 15 is a view explaining an account-based personalized home screen according to an embodiment of the present disclosure;

FIG. 16 is a view explaining an overall structure of a home view region and a dynamic view region according to an embodiment of the present disclosure;

FIG. 17 is a view illustrating an account creation example according to an embodiment of the present disclosure;

FIG. 18 is an illustrative view illustrating a home view region and a dynamic view region in a Theme mode account of FIG. 17 according to an embodiment of the present disclosure;

FIGS. 19, 20, 21, 22, 23, 24, 25A, 25B, and 25C are views explaining use of a home view region and a dynamic view region of FIG. 15 according to various embodiments of the present disclosure;

FIG. 26 is a view illustrating an example of a configuration and operation of a dynamic view region according to an embodiment of the present disclosure;

FIG. 27 is a view explaining an information object displayed in a dynamic view region according to an embodiment of the present disclosure;

FIG. 28 is a view explaining a recommendation of an information object to a dynamic view region according to an embodiment of the present disclosure;

FIG. 29 is a view explaining a process of displaying a history of an auto channel in a dynamic view region according to an embodiment of the present disclosure;

FIG. 30A is a view explaining a variable icon of which a function is changed according to a use context according to an embodiment of the present disclosure;

FIG. 30B is a view re-illustrating a key pad portion of element (b) of FIG. 30 according to an embodiment of the present disclosure;

FIG. 31 is a view explaining an attribute for creating a macro icon in a home screen according to an embodiment of the present disclosure;

FIGS. 32A, 32B, and 32C are detailed views illustrating a process of setting a condition for varying a macro icon of FIGS. 30A and 30B according to various embodiments of the present disclosure;

FIG. 33 is a view explaining a shortcut to a history screen through a macro icon created in a home screen according to an embodiment of the present disclosure;

FIG. 34 is a view explaining a process of creating a propose icon in a home screen according to an embodiment of the present disclosure;

FIG. 35 is a view illustrating a log map illustrated in element (b) of FIG. 34 according to an embodiment of the present disclosure;

FIG. 36 is a view explaining an edit process of a web list according to an embodiment of the present disclosure;

FIG. 37 is a view explaining a process of creating a search icon according to an embodiment of the present disclosure;

FIGS. 38A, 38B, and 38C are detailed views illustrating a process of creating a search icon of FIG. 37 according to various embodiments of the present disclosure;

FIG. 39 is a view explaining a searching result in response to keywords being the same and attributes being different according to an embodiment of the present disclosure;

FIG. 40 is a view illustrating an example in which a variable icon is applied to a television (TV) according to an embodiment of the present disclosure;

FIG. 41 is a flowchart illustrating a process of driving an image display apparatus according to an embodiment of the present disclosure; and

FIG. 42 is a flowchart illustrating an image display method according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

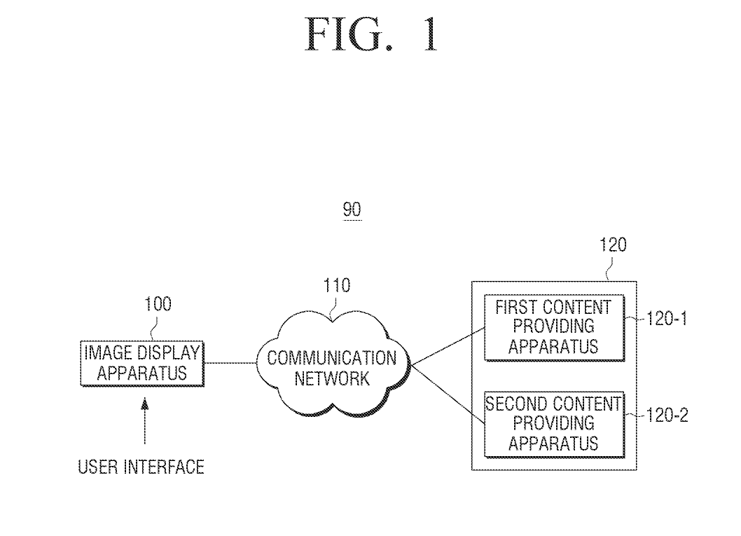

FIGS. 1 through 42, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

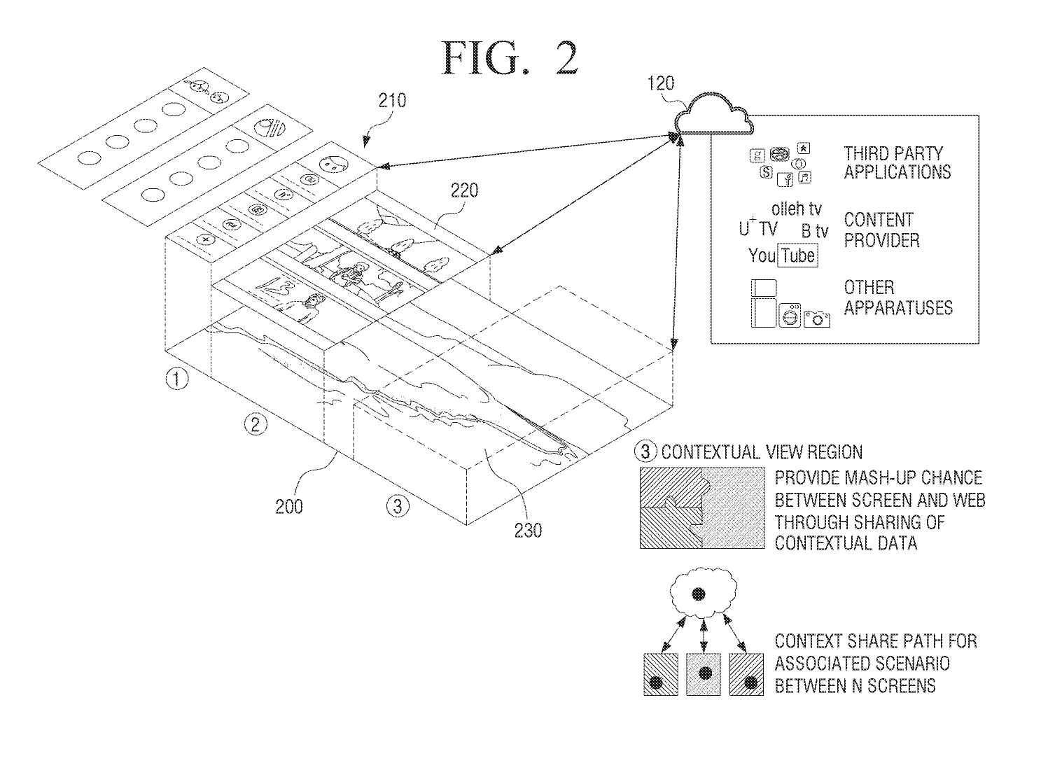

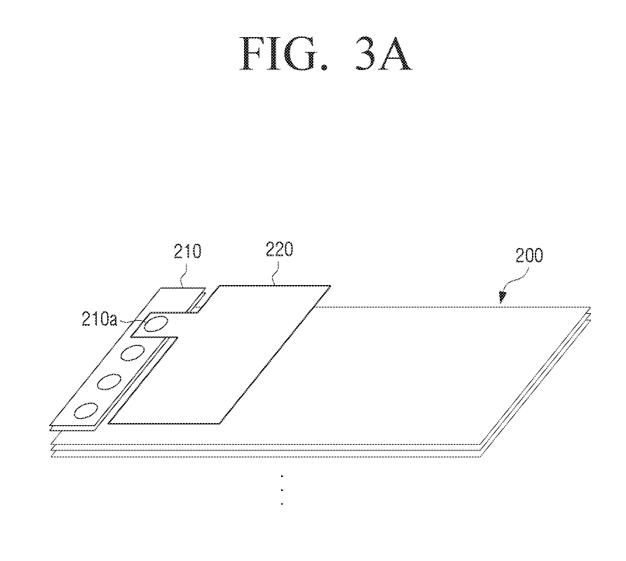

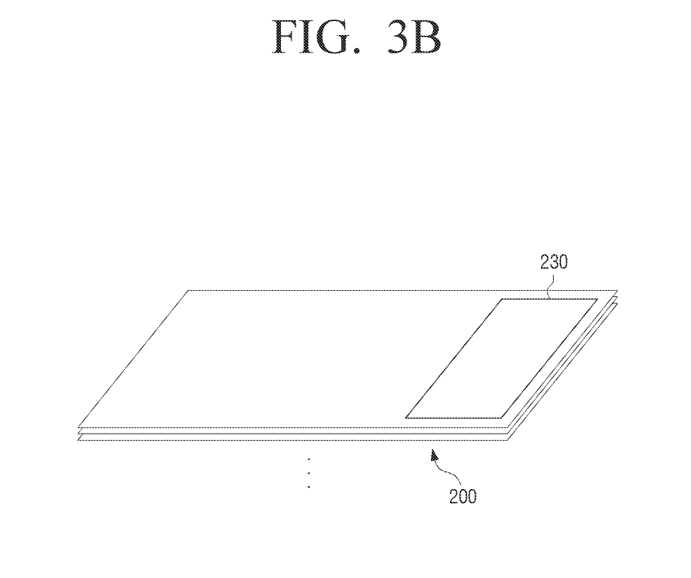

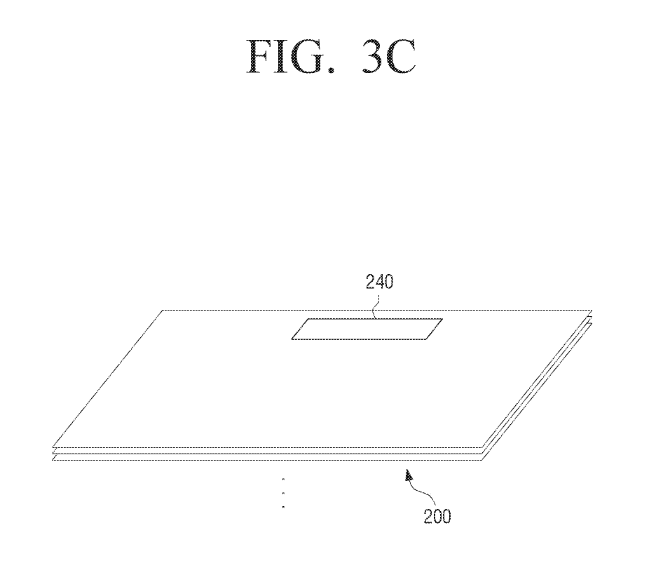

FIG. 1 is a view illustrating a user-based screen providing service system according to an embodiment of the present disclosure, FIG. 2 is a view illustrating schematics of various types of views displayed in an image display apparatus of FIG. 1 in one screen according to an embodiment of the present disclosure, and FIGS. 3A, 3B, and 3C are detailed views illustrating a realization state of various types of views according to a user command according to various embodiments of the present disclosure.

Referring to FIG. 1, a user-based screen service providing system 90 according to an embodiment of the present disclosure is illustrated, where the user-based screen service providing system 90 partially or entirely includes an image display apparatus 100, a communication network 110, and a content providing apparatus 120, including, for example, a first content providing apparatus 120-1 and a second content providing apparatus 120-2.

The phrase “partially or entirely include” means that the user-based screen service providing system 90 may be configured that a portion of configuration components such as the communication network 110 may be omitted, and the image display apparatus 100 may implement a screen providing service through direct communication with the content providing apparatus in the periphery thereof. For a thorough understanding of the present disclosure, the embodiment of the present disclosure will be described that all the configuration components are included in the user-based screen service providing system 90.

The image display apparatus 100 includes various apparatuses which may display an image, such as a digital television (DTV), a smartphone, a laptop computer, a desktop computer, a tablet personal computer (PC), a portable multimedia player (PMP), an MP3 player, or a wearable apparatus. For example, the image display apparatus 100 such as a TV may be linked with a broadcasting receiving apparatus such as a set-top box (STB). The image display apparatus 100 may display various types of information objects in a screen of the image display apparatus 100. The various types of information objects include a still image and a moving image implemented with a unit screen. For example, the still image includes a photo, a web browser, and a directory screen, and the moving image includes broadcast program content.

The image display apparatus 100 according to an embodiment of the present disclosure may define, for example, four additional view regions as illustrated in FIGS. 2 to 3C.

Referring to FIGS. 2 to 3C, a unit screen 200 is illustrated, where additional view regions display additional views in various types in a separated form from an image of the unit screen 200 are currently displayed in the image display apparatus 100 of FIG. 1 without a break of watching flow of the user. The four additional view regions include a home view region 210, a dynamic view region 220, a contextual view region 230, and a banner view region 240. The home view region 210 and the dynamic view region 220 may be simultaneously displayed, and images having different attributes from each other or information of the images may be displayed in the home view region 210 and the dynamic view region 220. The content displayed in the home view region 210, the dynamic view region 220, the contextual view region 230 and the banner view region 240 may be received from or through a content providing apparatus 120, such as third party applications, various content providers and/or other apparatuses.

More specifically, in response to a user command (or a third user command) for calling the home view region 210 being presented in the state in which an image 1 (or a first image) is displayed in the current unit screen 200 of the image display apparatus 100, the home view region 210 and the dynamic view region 220 are displayed in the screen as illustrated in FIG. 3A. An image 2 (or a fourth image) and an image 3 (or a fifth image) may be displayed in the home view region 210 and the dynamic view region 220, respectively. The user command for calling the home view region 210 may be performed through a home key of a remote control device such as a remote controller, but the user command for calling the home view region 210 may be performed a key installed in the image display apparatus 100 and voice recognition. The key may also include a touch type key.

The image 2, which is displayed in the home view region 210 includes a list of an execution icon 210a that the user freely registers, calls a desired object in a form of the unit screen 200. The execution icon 210a means an icon configured to change the image 1 displayed in the current unit screen 200 of the image display apparatus 100 to a new type of information object. That is, the execution icon 210a is used for conversion of the information object unit perceived by the user in the image display apparatus 100.

The image 3 displayed in the dynamic view region 220 may be displayed to match with the execution icon 210a. For example, the image 3 matching with the execution icon 210a in which a current highlight (or a cursor) is located may be displayed in the dynamic view region 220. Therefore, the dynamic view region 220 may display a status or information of another view, that is, another information object with the image 3, and the image 3 may be separately displayed from the image 1 displayed in a current screen, that is, the unit screen 200 so as not to disturb viewing immersive experience of the user. That is, the image 3 may be displayed so as not to cover the unit screen 200 of the image 1. The image 3 may become an image which is finally viewed by the user through the execution icon 210a.

Referring to FIG. 3B, in response to a user command (or a first user command) for calling a contextual view region 230 being presented, the home view region 210 and the dynamic view region 220 disappear from the image display apparatus 100, and the contextual view region 230 is displayed in a preset region. The contextual view region 230 may also be separately displayed from the image 1 in a partial view form so as not to cover the image 1. The contextual view region 230 displays an image 4 (or a second image), and the image 4 represents related information collected using key information of the image 1 displayed in the current unit screen 200.

As will be described later again, the key information may correspond to data determined to be more important than other data among metadata related to the image 1. For example, in response to the image 1 being related to an album of a specific singer, the metadata may include a title, an artist (name), an album, and a genre, and the key information may be the artist (name) among the metadata. Therefore, the contextual view region 230 may represent the artist-related information. For example, in response to a concert related to the artist being scheduled, the contextual view region 230 may represent the concert-related information. The related information may be received from a plurality of information sources such as the first content providing apparatus 120-1 and the second content providing apparatus 120-2, as illustrated in FIG. 1, according to an execution of a program or application stored in the image display apparatus 100, and then displayed.

In the above-described process, the related information may be filtered and then displayed again. In other words, the related information may be received from various information sources using metadata, and may be filtered based on the key information. According to various embodiments of the present disclosure, the information source may be changed in any degree according to the key information. Further, since programs or applications stored by users may be different from each other, the information represented in the contextual view region 230 may be different according to the users even in the same key information being used.

The image display apparatus 100 provides a mash-up chance between a screen and a web through sharing of context data, that is, information related to the displayed screen so as to provide the contextual view region 230 as illustrated in FIG. 2. The mash-up means that new service is made by merging various pieces of service which are provided in Internet and different from each other. The image display apparatus 100 has a context-sharing passage for an interconnection scenario between N screens constituting the contextual view region 230.

In response to the banner view region 240, as illustrated in FIG. 3C, being called by the user through a user command (or a second user command), the home view region 210 and the dynamic view region 220 as illustrated in FIG. 3A or the contextual view region 230 as illustrated in FIG. 3B disappear in the image display apparatus 100, and the banner view region 240 is displayed together with the current unit screen 200 displayed in the image display apparatus 100. The banner view region 240 may be separately displayed from the image 1 in a partial view form. Substantially, since the banner view region 240 does not largely cover the unit screen 200, the banner view region 240 may be displayed to overlap the unit screen 200.

The banner view region 240 may represent a name and representative information related to the image 1 displayed in the current unit screen 200, and may schematically display a similar neighboring view. In other words, the banner view region 240 may represent a channel name and a channel number of the image 1. For example, in response to the image 1 displayed in the current unit screen 200 being a screen related to channel 7 of KBS, the banner view region may represent information corresponding to channel 5 or channel 11 in the same time zone. Further, the banner view region 240 may display information related to an image watched in the past together with the information related to the image 1 displayed in the current unit screen 200, or the banner view region 240 may further display information reserved on an electronic program guide (EPG). For example, the past information may be information corresponding to programs of the same genre.

The banner view region 240 may further display auto channeling information. As will be described in detail later, in response to the auto channeling function being set by the user, the image display apparatus 100 analyzes a viewing pattern of the user, and provides a corresponding broadcasting program through auto channeling in response to a user favorite channel being broadcasted at a corresponding time through an analysis result. The image display apparatus 100 may perform automatic channel change on a user watchable channel, and provide a broadcasting program corresponding to the user watchable channel even in response to separate channel zapping, that is, fast channel shift being not presented in the auto channeling selection.

The communication network 110 includes all wired and wireless communication networks. The wired communication network may include a cable network or an Internet network such as a public switched telephone network (PSTN), and the wireless communication network may include code division multiple access (CDMA), wideband CDMA (WCDMA), global system for mobile communication (GSM), evolved packet core (EPC), long term evolution (LTE), a wireless broadband (WiBro) network, and the like.

The communication network 110 in an embodiment of the present disclosure is not limited thereto. The communication network 110 is an access network for a next-generation mobile communication system to be realized in the future, and for example, the communication network 110 may be used for a cloud computing network under cloud computing environments. In response to the communication network 110 being a wired communication network, an access point in the communication network 110 may access a central office of a telephone company, and the like. However, in response to the communication network 110 being a wireless communication network, the communication network 110 may access to a serving general packet radio service (GPRS) support node (SGSN) or a gateway GPRS support node (GGSN) operating in a service provider and process data or may access to various relays such as a base station transmission (BTS), a NodeB, and/or an evolved NodeB (e⁻NodeB) and process data.

The communication network 110 may include an access point. The access point includes a small base station such as a femto or pico base station mainly installed in a building. The femto or pico base station is classified according to the maximum number of image display apparatuses 100 accessed to the base station on a classification of the small base station. The access point includes a near field communication module configured to perform near field communication such as Zigbee, and/or Wi-Fi with the image display apparatus 100. The access point may uses a transfer control protocol/Internet protocol (TCP/IP) and/or a real time streaming protocol (RTSP) for wireless communication. The near field communication may be performed with various standards such as Bluetooth, Zigbee, infrared data association (IrDA), radio frequency (RF) such as ultra high frequency (UHF) and/or very high frequency (VHF), and/or ultra wide band (UWB) other than Wi-Fi. Thus, the access point may extract a location of a data packet, designate the best communication path for the extracted location, and transfer the data packet to next apparatus, for example, the image display apparatus 100 according to the designated communication path. The access point may share multiple lines in a general network environment, and for example, the access point may include a router, a repeater, a relay, and/or the like.

The content providing apparatus 120 may include a plurality of content providing apparatuses which are operated as a content or information source of the image display apparatus 100. For example, in response to the first content providing apparatus 120-1 being a server operating in a broadcasting station, the second content providing apparatus 120-2 may be a server operating in a specialized search portal company, such as Naver™. The image display apparatus 100 may access to the first content providing apparatus 120-1 to be operated in response to a broadcasting program being watched by the user through the image display apparatus 100, and the image display apparatus 100 may access to the second content providing apparatus 120-2 to be operated in response to Internet searching being necessary.

The content providing apparatus 120 may provide various pieces of additional information according to the request of the image display apparatus 100. For example, the first content providing apparatus 120-1 may provide metadata related to a broadcasting program, and then may provide the broadcasting program. In response to the metadata being not separately provided, the first content providing apparatus 120-1 may search for information according to the request of the image display apparatus 100, and provide the searched information. For example, in response to key information being provided from the image display apparatus 100, the first content providing apparatus 120-1 may provide related information searched based on the key information to the image display apparatus 100. The related information may be a good example of information displayed in the contextual view region 230.

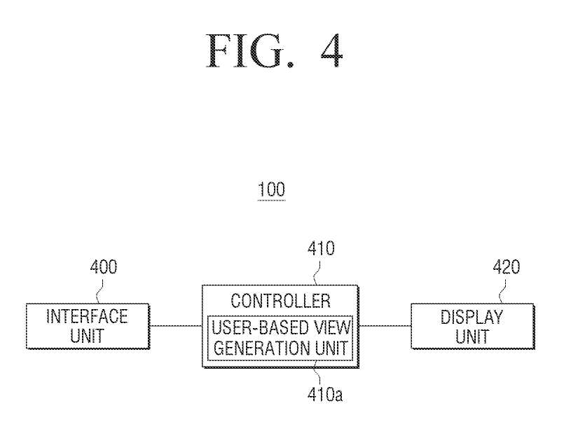

FIG. 4 is a block diagram illustrating a structure of an image display apparatus illustrated in FIG. 1 according to an embodiment of the present disclosure.

Referring to FIG. 4 together with FIG. 1, an image display apparatus 100 is illustrated, such that according to an embodiment of the present disclosure the image display apparatus 100 partially or entirely includes an interface unit 400, a controller 410, and a display unit 420.

The phrase “partially or entirely include” means that the image display apparatus 100 may be configured that a portion of configuration components such as the interface unit 400 may be omitted, or the interface unit 400 may be integrated with another configuration component such as the display unit 420. For a thorough understanding of the present disclosure, the embodiment of the present disclosure will be described that all the configuration components are included in the image display apparatus 100.

The interface unit 400 includes at least one of a communication interface unit and a user interface unit. In response to the interface unit 400 being the communication interface unit, the interface unit 400 may serve to receive a user command through a remote controller, and to request content or information to the external content providing apparatus 120 and receive the requested content or information from the external content providing apparatus 120. For example, the interface unit 400 may include input keys configured to input a user command, such as a power key. Further, the interface unit 400 may include a voice recognition unit configured to acquire the user command in a voice type. The voice recognition unit may include a microphone or the like.

The controller 410 may serve to perform an overall control of the interface unit 400 and the display unit 420 in the image display apparatus 100. For example, in response to a user command for calling a user-based screen being received through the interface unit 400, the controller 410 may execute a user-based view generation unit 410a to display user-based views on the display unit 420. As described in FIGS. 3A to 3C, the user-based views may have different internal information attributes according to the user, and the user-based views may mean the home view region 210, the dynamic view region 220, the contextual view region 230, and the banner view region 240.

For example, the user-based view generation unit 410a may allow the home view region 210 and the dynamic view region 220 to be formed on the same layer as the unit screen 200, and to be separately displayed from the unit screen 200 in a partial view form. For this, the controller 410 may divide the screen of the display unit 420, and control pieces of data to provide the divided regions, respectively. In other words, the controller 410 may provide image data for the home view region 210 and the dynamic view region 220 to the left of the screen of the display unit 420, and provide image data for the unit screen 200 in the right of the screen of the display unit 420. The user-based view generation unit 410a may allow the contextual view region 230 to be formed on the same layer as the unit screen 200, and to be separately displayed from the unit screen 200 in a partial view form. The user-based view generation unit 410a may allow the banner view region 240 to be formed on a different layer from the unit screen 200, and to be displayed in a pop-up window form.

The user-based view generation unit 410a may be implemented in software, that is, a program type, and the controller 410 may further include a central processing unit (CPU) configured to execute a program in the user-based view generation unit 410a. The user-based view generation unit 410a may be a memory such as a random access memory (RAM), but the user-based view generation unit 410a may be implemented with a memory such as a read only memory (ROM) configured to permanently store a program, or to periodically write or erase the program such as a mask ROM, an electrically programmable ROM (EPROM), and/or an electrically erasable and programmable ROM (EEPROM).

The display unit 420 may display views differently configured based on the user commands, and display different pieces of information in regions of the views. Typically, the display unit 420 may display the image 1 in the unit screen 200 of FIG. 2, and display information related to the displayed image 1 in the contextual view region 230. The related information displayed in the contextual view region 230 is not directly related to the information displayed in the image 1. In other words, in response to an artist being displayed in the image 1, the display unit 420 may not provide an information type provided by selecting a search word for the artist but may provide the related information provided using key data among the metal data related to the displayed image 1.

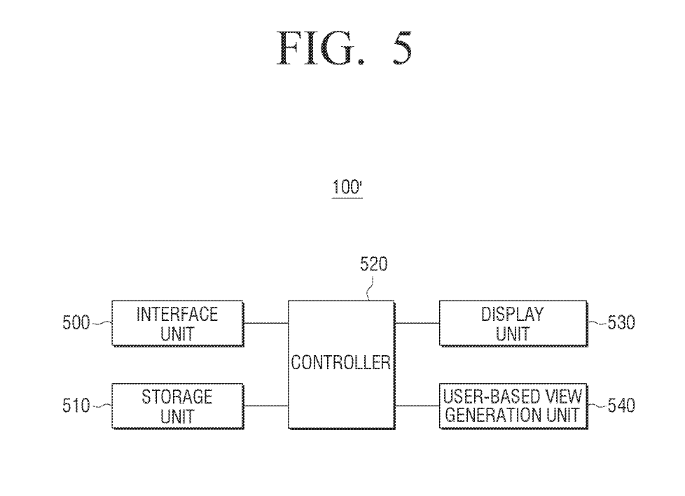

FIG. 5 is a block diagram illustrating a structure of an image display apparatus illustrated in FIG. 1 according to an embodiment of the present disclosure.

Referring to FIG. 5, an image display apparatus 100′ according to an embodiment of the present disclosure is illustrated, where the image display apparatus 100′ partially or entirely includes an interface unit 500, a storage unit 510, a controller 520, a display unit 530, and a user-based view generation unit 540.

The phrase “partially or entirely include” means that the image display apparatus 100′ may be configured that a portion of configuration components such as the storage unit 510 may be omitted, or the storage unit 510 is integrated with the user-based view generation unit 540. For a thorough understanding of the present disclosure, the embodiment of the present disclosure will be described that all the configuration components are included in the image display apparatus 100′.

The interface unit 500, the controller 520, the display unit 530, and the user-based view generation unit 540 according to the embodiment of the present disclosure illustrated in FIG. 5 are substantially the same as the interface unit 400, the controller 410, the controller 410 including the user-based view generation unit 410a, and the display unit 420 illustrated in FIG. 4, and detailed description thereof will be omitted.

Merely, the controller 410 of FIG. 4 has a structure including, for example, a CPU and a memory. The controller 410 may include a software (SW) module related to generation of the user-based view in the memory, and the SW module may be executed under the control of the CPU or all a control operation and an operation related to view generation may be implemented with the SW module. However, the controller 520 of FIG. 5 may be implemented with a hardware (HW) module together with the user-based view generation unit 540. The controller of FIG. 5 may execute the software module in the user-based screen generation unit 540 through the CPU, and receive an execution result and perform the control operation. In this case, the user-based view generation unit 540 may be configured of a memory such as a mask ROM, an EPROM, or an EEPROM.

In this regard, the user-based view generation unit 540 may also be included in the scope of the storage unit 510. However, the user-based view generation unit 540 may be operated as a nonvolatile memory, but the storage unit 510 may be operated as a volatile memory such as a RAM. Thus, the storage unit 510 may temporarily store data or information processed under the control of the controller 520, and output the stored data or information according to the request of the controller 520.

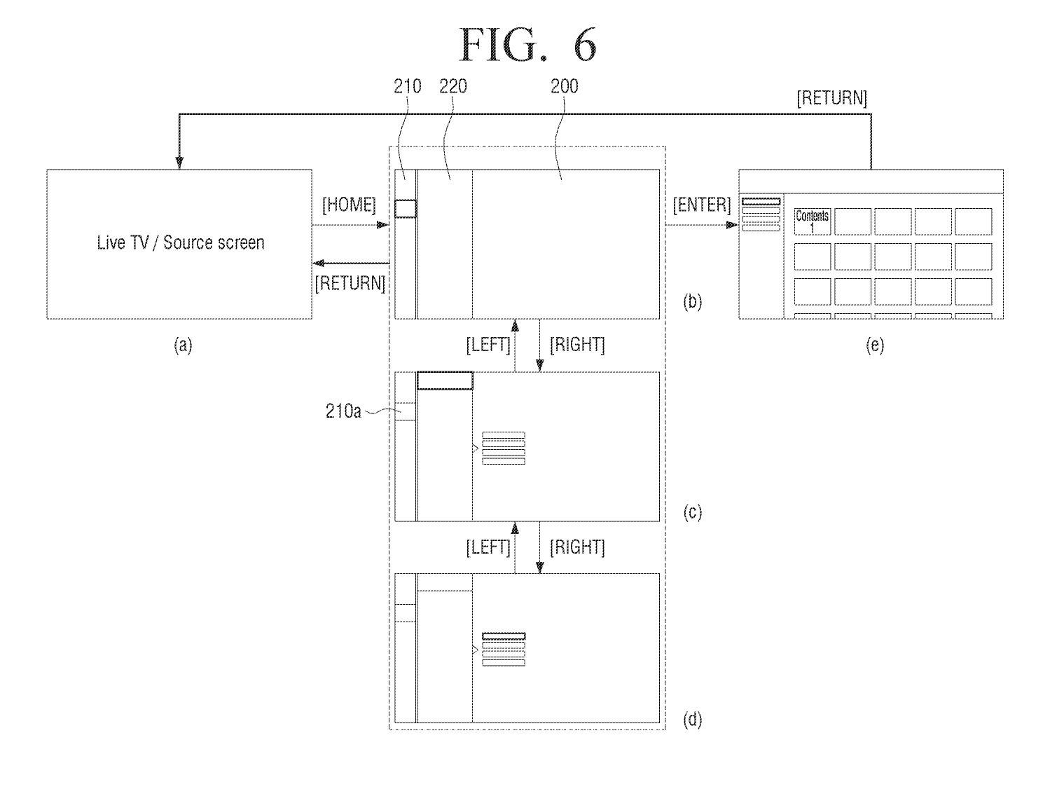

FIG. 6 is a view explaining a screen conversion of a home view region and a dynamic view region of FIG. 2 according to an embodiment of the present disclosure.

For clarity, referring to FIG. 6 together with FIG. 1, the image display apparatus 100 according to an embodiment of the present disclosure displays an image 1 (e.g., live TV) according to a user command as illustrated in element (a) of FIG. 6.

Then, the image display apparatus 100 performs conversion to a view as illustrated in element (b) FIG. 6 in response to a user command for calling a home view region 210 of a screen unit 200 from the user being presented. The image display apparatus 100 returns to the screen as illustrated in element (a) of FIG. 6 using a RETURN key or a directional key.

The image display apparatus 100 may change an execution icon 210a using UP/DOWN directional keys in the state in which the home view region 210 and the dynamic view region 220 are displayed. The image display apparatus 100 may display a screen in which information is changed using LEFT/RIGHT directional keys in the state in which the execution icon 210a is fixed as illustrated in elements (c) and (d) of FIG. 6.

Further, in response to the specific execution icon 210a being selected using an ENTER key in the screen state as illustrated in element (b) of FIG. 6, the image display apparatus 100 may display a web browser screen as illustrated in element (e) of FIG. 6 matching with the corresponding execution icon 210a. In response to the RETURN key being selected in the state in which the screen as illustrated in element (e) of FIG. 6 is displayed, the image display apparatus may return to the screen as illustrated in element (a) of FIG. 6.

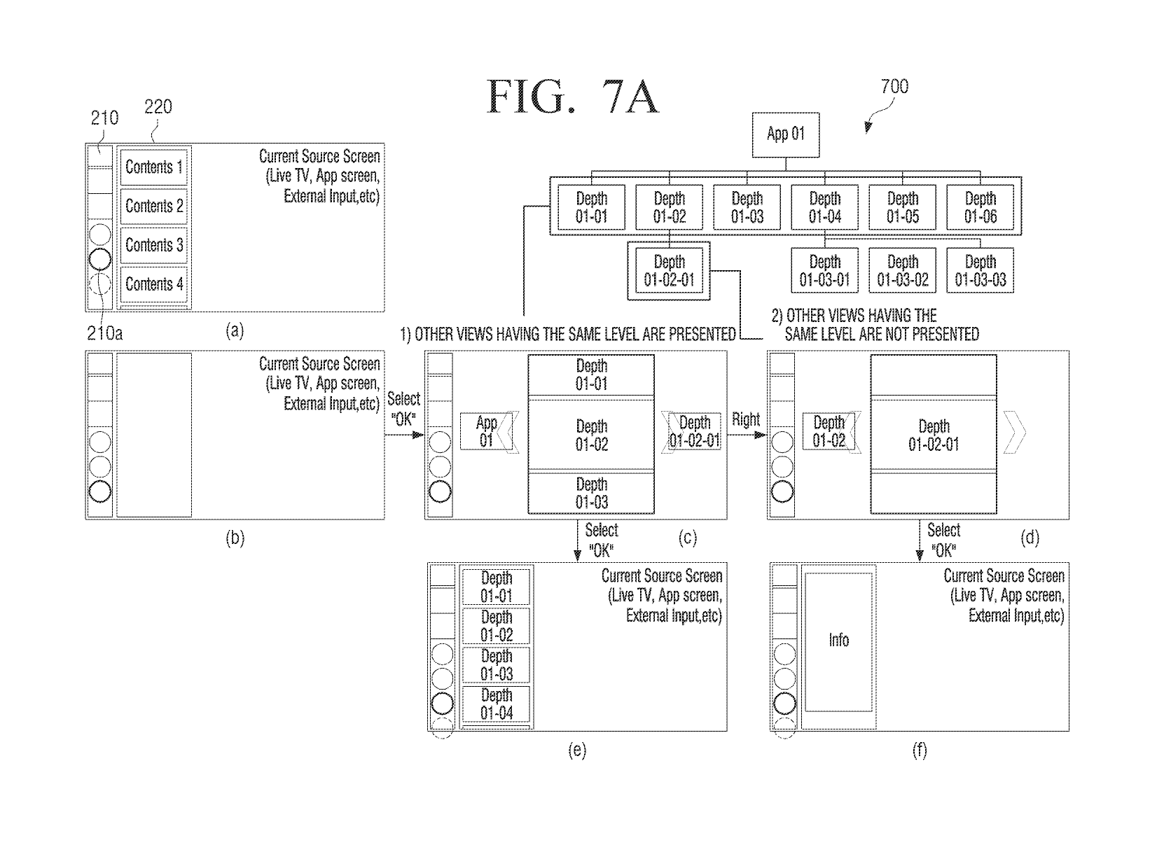

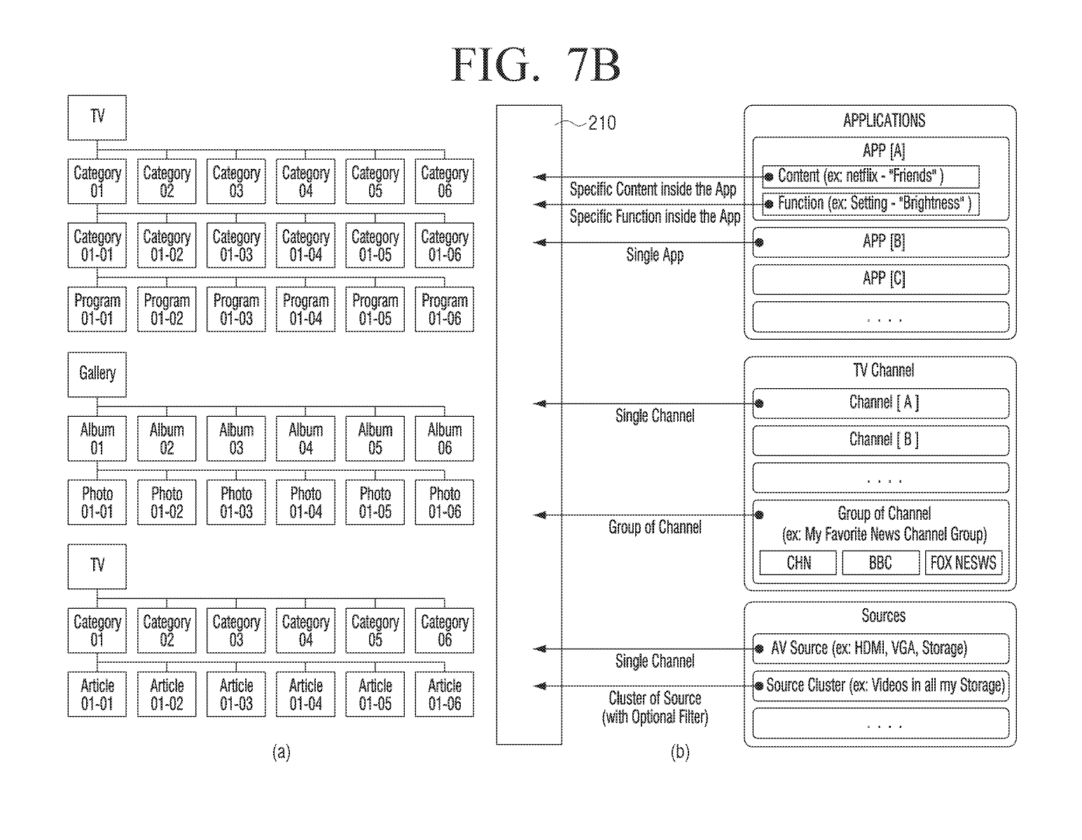

FIG. 7A is a view explaining a process of registering an information object through matching with an execution icon of a home view region regardless of an information level according to an embodiment of the present disclosure.

For clarity, referring to FIG. 7A together with FIG. 1, an image display apparatus 100 according to an embodiment of the present disclosure may basically provide all screen objects used in a TV, such as a channel having an information-structural depth, an application, a web page, a source (for example, external input), or a setup menu, on a screen. The image display apparatus may select an object frequently used by the user or an object having a desired depth, and register the selected object to a new screen. That is, the user may directly select, register, and use a screen item in a system in which the object is provided to the screen in application and function units.

For example, in the state in which a home view region 210 is displayed as illustrated in element (a) of FIG. 7A, the image display apparatus 100 may shift an execution icon 210a using a directional key, and allow a dynamic view regions 220 having different pieces of information from each other to be displayed as illustrated in element (b) of FIG. 7A.

In response to the specific execution icon 210a being selected in the state in which the dynamic view region 220 is displayed, a screen as illustrated in element (c) of FIG. 7A may be displayed. In other words, in response to other views having the same level being presented as illustrated in element (c) of FIG. 7A, a screen as illustrated element (d) of in FIG. 7A may be displayed. For example, in response to a LEFT directional key of a remote controller being selected in the screen state as illustrated in element (c) of FIG. 7A, an information object displayed in element (c) of FIG. 7A may be shifted to the left, and an information object as illustrated in element (d) of FIG. 7A may be displayed in the same region in which the information object of element (c) of FIG. 7A is displayed.

In response to other views having the same level being not presented in the state in which the screen as illustrated in element (d) of FIG. 7A is displayed, no information object is further displayed even in response to the LEFT directional key of the remote controller being selected. This may be seen through a depth-structural table 700 of FIG. 7A.

In response to an OK key for registration being selected after a highlight (or a cursor) is shifted to an information object having a specific depth in the screen state as illustrated in element (c) of FIG. 7A, corresponding information objects may match with new execution icons, and may be registered as new views as illustrated in element (e) of FIG. 7A. Similarly, in response to the OK key for registration being selected after the highlight (or the cursor) is shifted to an information object in the screen state as illustrated in element (d) of FIG. 7A, the corresponding information object may be registered to a new view matching with a new execution icon as illustrated element (f) of FIG. 7A.

The image display apparatus 100 may register various information objects displayed in the views through matching with the execution icons 210a regardless of depths thereof. The phase “register as the execution icons 210a” means “automatically shift to a view having a corresponding depth only through simple selection of the execution icon 210a”. Such a view may be displayed as a full screen of the image display apparatus 100.

FIG. 7B is a view explaining a concept of a view level according to an application and a screen list according to an embodiment of the present disclosure.

According to various embodiments of the present disclosure, the image display apparatus 100 of FIG. 1 may allow various types of information objects, such as a broadcasting (e.g., a TV) program, a photo (e.g., a photo gallery), or a blog to be views without the limitation of an information level, that is, a depth as illustrated in element (a) of FIG. 7B. In other words, the image display apparatus may enter a corresponding view, register the corresponding view, and then make the corresponding view through a selection of the user for an execution icon matching with the corresponding view registered in a home view region 210.

For example, the image display apparatus 100 may register an application, a broadcasting program, and various sources to the home view region 210 regardless of information levels, that is, depths thereof, and allow the application, the broadcasting program, and the various sources to be displayed in an execution icon list of the home view region 210 as illustrated in element (b) of FIG. 7B.

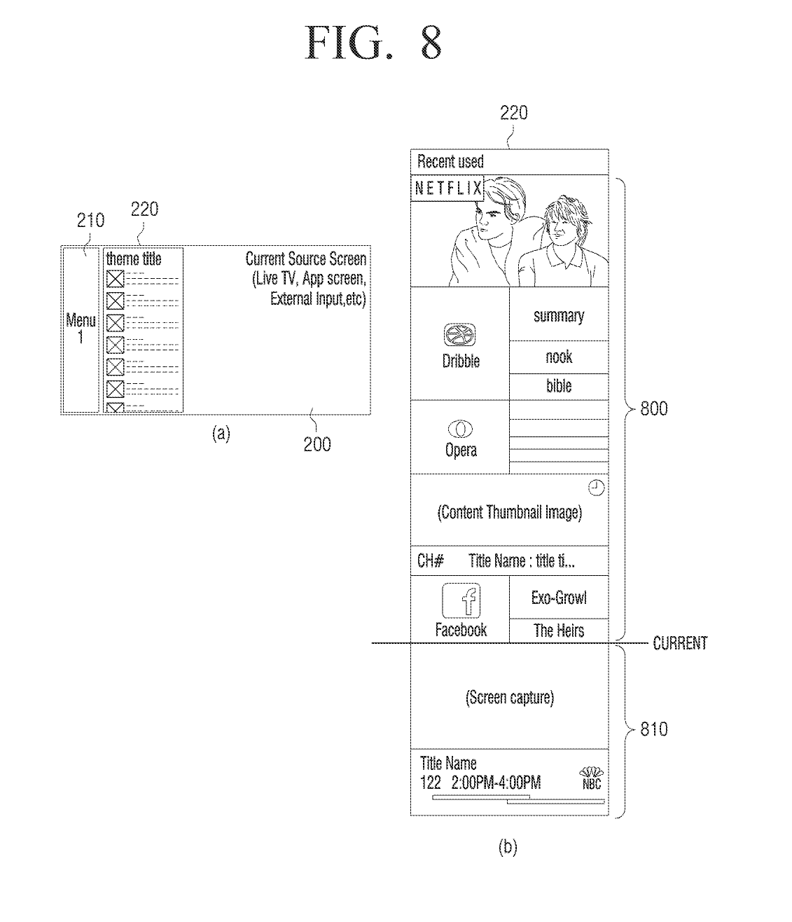

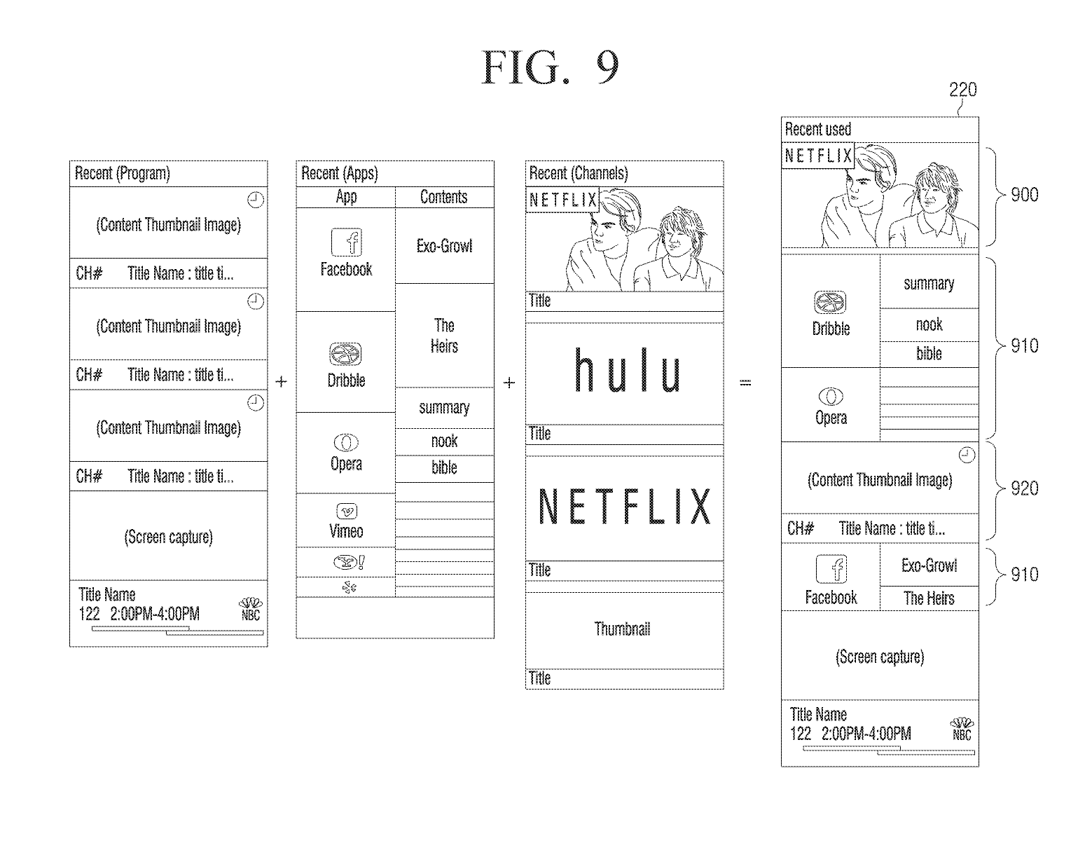

FIG. 8 is a view explaining the dynamic view region of FIG. 2 according to an embodiment of the present disclosure, and FIG. 9 is a view illustrating an example of generating a dynamic view region illustrated in FIG. 8 according to an embodiment of the present disclosure.

For clarity, referring to FIGS. 8 and 9 together with FIG. 1, the image display apparatus 100 according to an embodiment of the present disclosure displays a dynamic view region 220 together with a home view region 210 in response to a user command for calling the home view region 210 being received from the user. For example, the home view region 210 and the dynamic view region 220 are provided in a partial view form separately from the current unit screen 200 displayed in the image display apparatus 100 so as not to disturb watching immersive experience in a TV, as illustrated in element (a) of FIG. 8. The image display apparatus 100 supports multitasking for the partial view. The state or information of other views may be checked through the dynamic view region 220. Further, the dynamic view region 220 may be configured of preview, a bookmark, a key function, a history, or the like according to a purpose of the view.

For example, as illustrated in element (b) of FIG. 8, the dynamic view region 220 may include a history view region 800 provided based on a previous viewing pattern of the user (for example, log data), and a recommendation view region 810 for a recommendation.

The history view region 800 may be formed of a combination of a channel information display region 900, an application information display region 910, and a program information display region 920, as displayed in the dynamic view region 200, and as illustrated in FIG. 9.

The channel information display region 900 may display a thumbnail image and outline information of a program, which is currently or recently broadcasted in a channel recently watched by the user and the corresponding channel, or a main program advertised as a key program.

The application information display region 910 may include content. The application information display region 910 may separately display a used application and content progressed based on the application, for example, a specific address of a web site, a specific feed, a receiver, music, data, or the like.

The program information display region 920 may display a specific program recently watched by the user and information of the specific program. In response to the corresponding program is ended, the program information display region 920 may directly shift to a related video on demand (VOD) view.

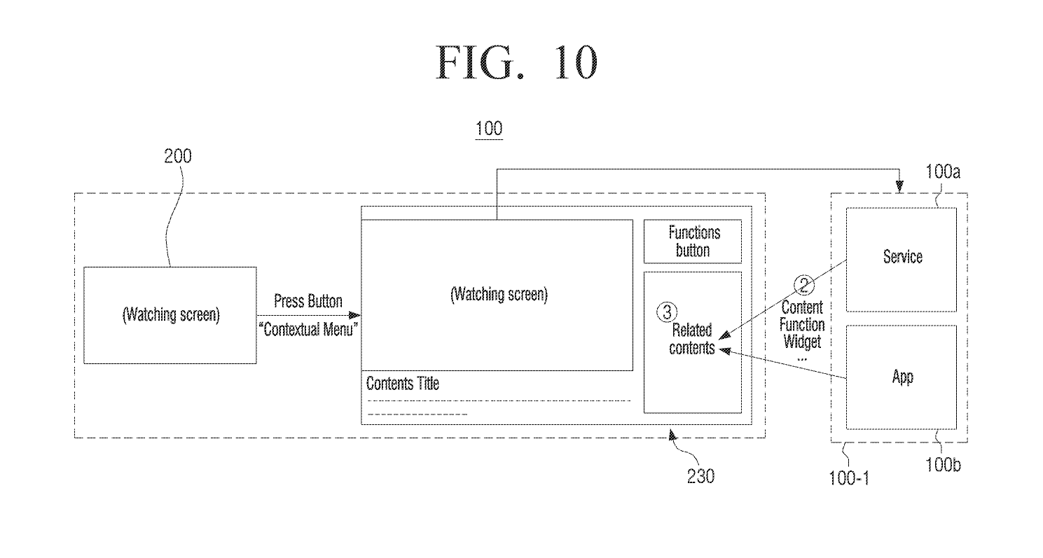

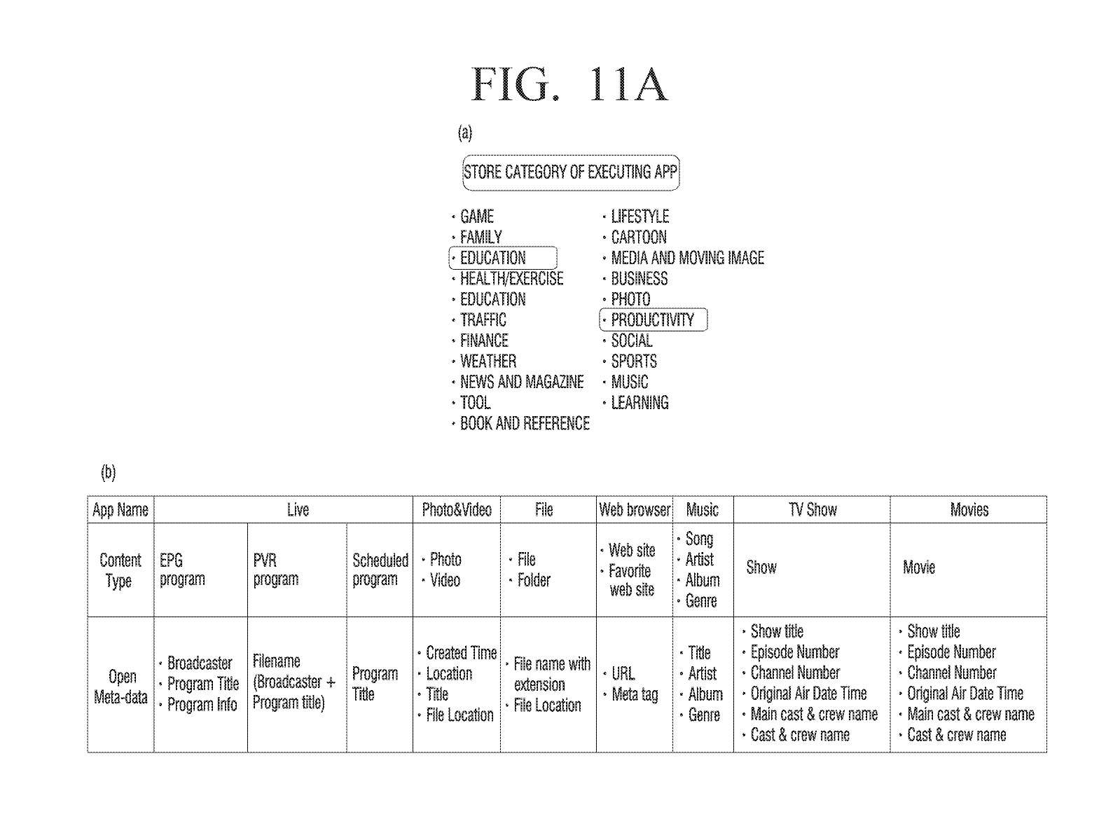

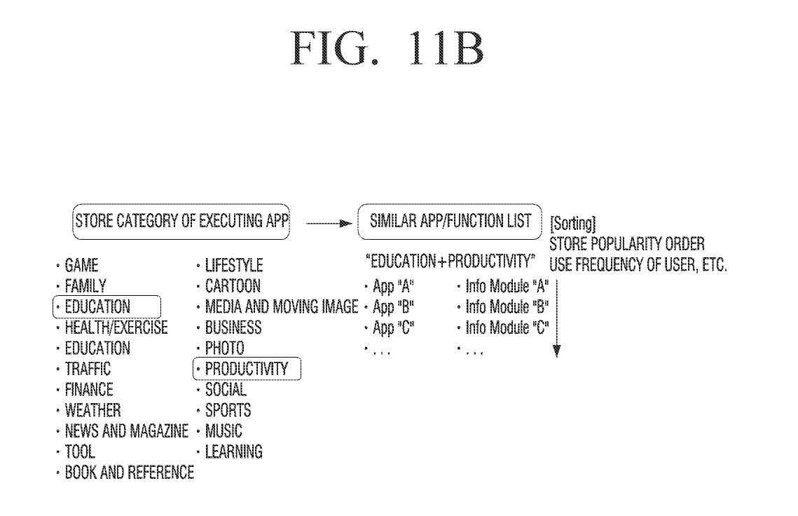

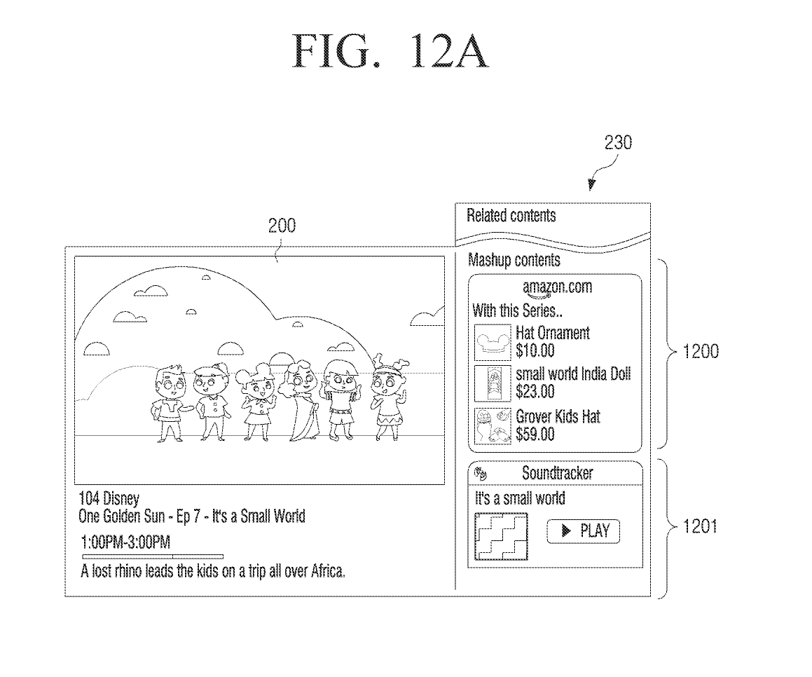

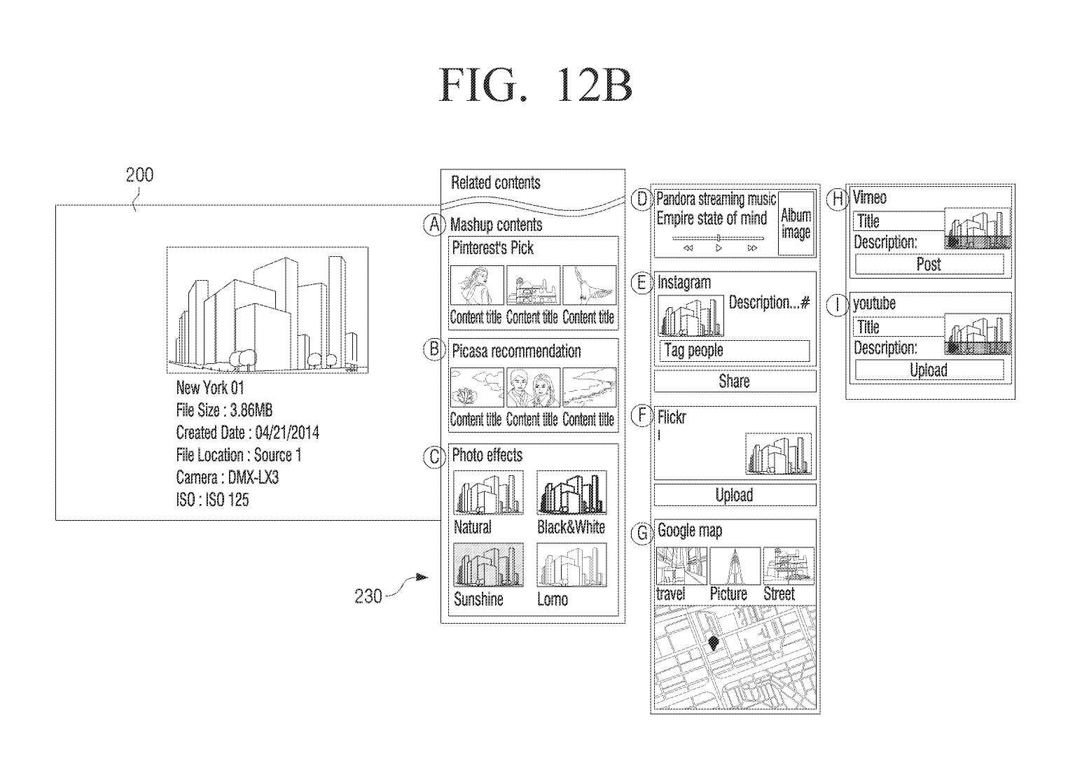

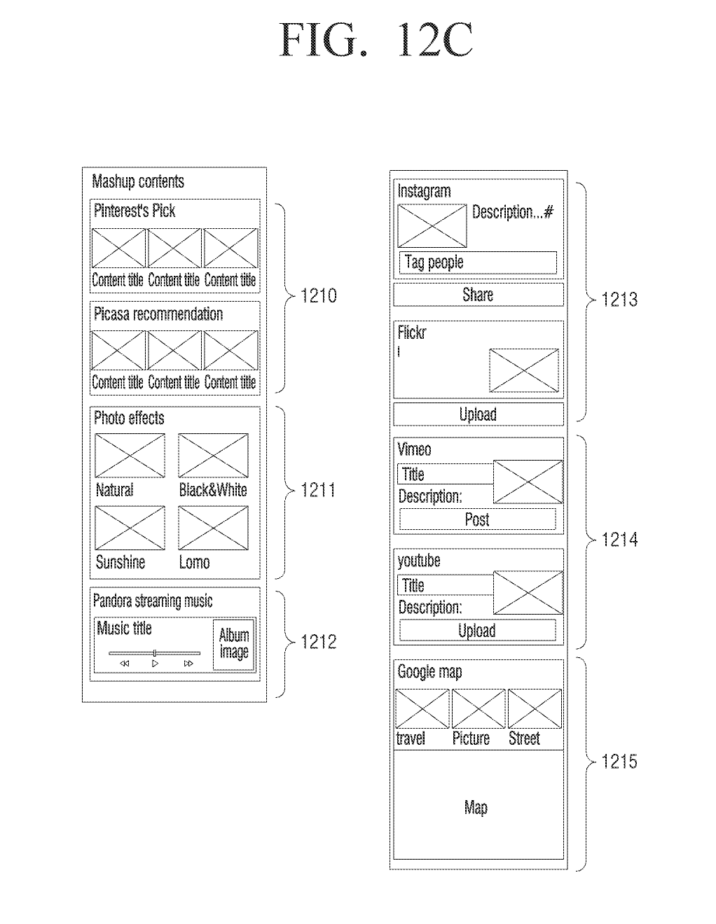

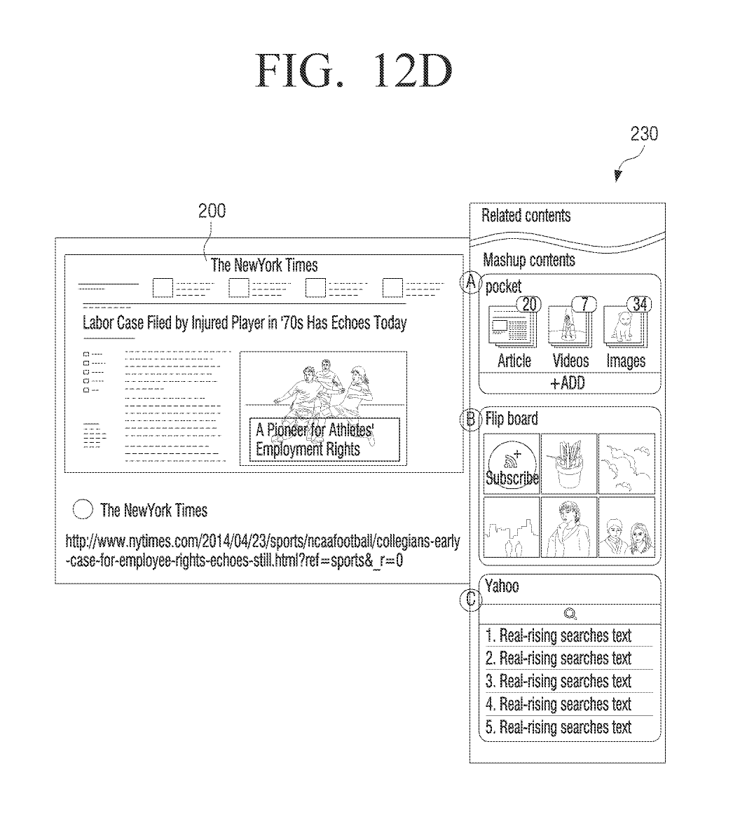

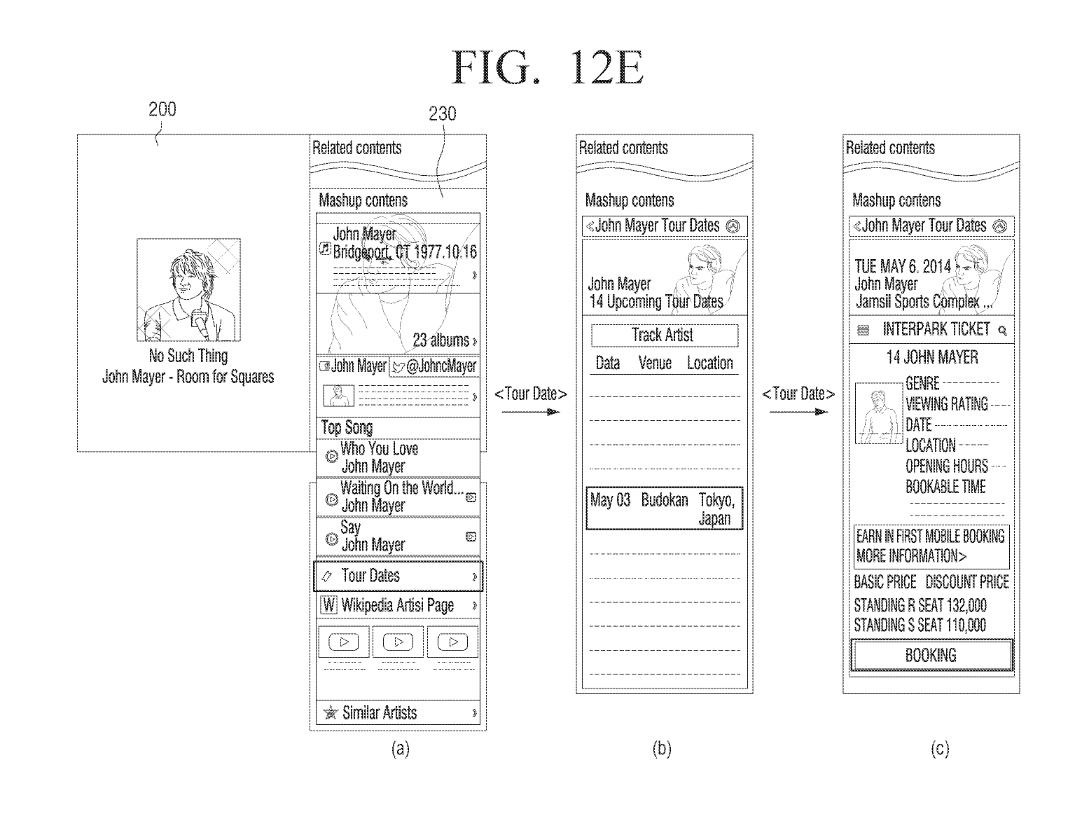

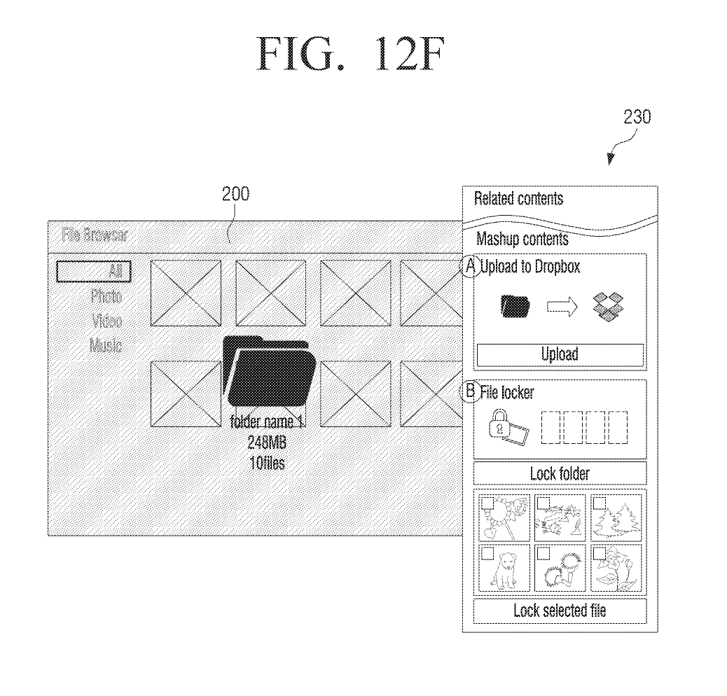

FIG. 10 is a view explaining a contextual view region of FIG. 2 according to an embodiment of the present disclosure, FIGS. 11A and 11B are views explaining a process of generating various pieces of information displayed in a contextual view region according to various embodiments of the present disclosure, and FIGS. 12A, 12B, 12C, 12D, 12E, and 12F are views illustrating various pieces of information displayed in a contextual view region according to various embodiments of the present disclosure.

Referring to FIG. 10, in response to a user command for calling a contextual view region 230 being input, that is, a key being pressed in a state in which a user being watching a TV with a unit screen 200, that is, a full screen 200, an image display apparatus 100 displays an image of the unit screen 200 in a first region thereof, and displays information related to the image 100-1 of the unit screen 200 in a second region, that is, the contextual view region 230. Herein, the information related to the image 100-1 may include service information 100a and application information 100b provided from the content providing apparatus 120, the first content providing apparatus 120-1 and the second content providing apparatus 120-2 of FIG. 1, based on transmitted metadata. For example, the image display apparatus 100 may display various types of information objects in the unit screen 200 as illustrated in FIGS. 12A to 12F. The information objects may include various types of images such as a live image, a photo or video image, a web browser image, a music image, a file browser image. An image constituting the unit screen 200 and information related to the image may be provided to the contextual view region 230.

The related information displayed in the contextual view region 230 may be provided using a frame search query and a key search query. In other words, as illustrated in element (a) of FIG. 11A, the frame search query may be extracted, for example, using a category item of an executing application. FIG. 11A (b) illustrates an example of metadata according to a type of contents. The key search query is key data executed in a current screen, and may be selected from metadata opened as illustrated in FIG. 11B. The metadata may be simultaneously provided in response to content being provided. However, in response to the metadata being not presented, the image display apparatus 100 may extract the metadata through screen analysis (for example, figure, text, place, or the like) or through voice and music analysis.

In order to represent information related to applications from which the frame is different on the contextual view region 230 in the above-described process, the following preparation for the application or program may be necessary. For example, the application developer may be defined in a user interface (UI) set form provided in the application similarly to a widget. In the service having no application, an extensible markup language (XML) page may be defined to correspond to a basic UI set provided from the contextual view region 230 as illustrated in FIG. 11B. For example, the service provider having no application may independently register only the frame (or a frame image) associated with its service in a store. The store may be the content providing apparatus 120 illustrated in FIG. 1.

More specifically, the searched frame described with reference to FIG. 11A is displayed through the following method. For example, the searched frame is displayed by applying the key data extracted from a context to a selected frame, the searched frame is displayed without change of data in the selected and distinguished frame, and the searched frame is displayed by applying the key data extracted from the context to a frame pre-designated in the application. Further, the searched frame is displayed without change of data in the frame designated in the application in advance. A frame recommended to be displayed, which is not the frame designated in the application in advance, is sorted and displayed based on the following criteria. The frame recommended to be displayed may be determined in popularity order in the application store as illustrated in FIG. 11B. Further, frequency of use of the application installed by the user may be used. For this, data between apparatuses may be linked, and thus the same recommended value between products owned by the user may be shared.

Referring to FIG. 12A, it is assumed that the user watches a Disney™ channel, and an image related to the Disney™ channel is provided to a unit screen 200. Further, a widget 1200 and a sound tracker 1201 may be displayed in a contextual view region 230. For example, Amazon™ may provide toys related to the program through the widget 1200, and the sound tracker 1201 may provide an original soundtrack (OST) album related to the episode. The widget 1200 is developed and provided in a third party manufacturer, and is related to program metadata. The widget 1200 may provide toys related to the program and price information together with thumbnail images for products. For example, the products may be high-ranked products. In response to a specific product being selected, the widget 1200 may shift to a product page on the application of Amazon™. The used metadata may be a program title and a broadcasting provider. In response to a “PLAY” key may be selected in the sound tracker 1201 by the user, a corresponding album may be reproduced on a sound tracker application. The used metadata may be a program title and program information.

Referring to FIG. 12B, the image display apparatus 100 of FIG. 1 may provide images related to a photo and video to a unit screen 200. The images may also be provided through execution of a plurality of applications related to the image and video. A contextual view region 230 may represent related information related to the photo and video provided to the current unit screen 200.

As illustrated in FIG. 12B, \textcircled{A} to \textcircled{I} indicate related information provided through execution of different applications from each other. \textcircled{A} and \textcircled{B} provide different photos related to a location or generation data. In response to the photo being selected, the views of \textcircled{A} and \textcircled{B} shift to an application or a web browser. \textcircled{C} provides effect options related to content, and \textcircled{D} provides a sing related to a location. In response to the view of \textcircled{D} being selected, the selected song may be executed as a background music. \textcircled{E} is a photo sharing widget, and \textcircled{F} is an upload widget. Description for the photo may be written through the photo sharing widget and the upload widget. \textcircled{G} may provide a travel photo, a map or the like related to a location, and in response to the view of \textcircled{G} being selected by the user, the view of \textcircled{G} may shift to a related uniform resource locator (URL) in Google™. \textcircled{H} indicates a post widget, and \textcircled{I} an upload widget, and a title or description of a video may be written. In response to the key of \textcircled{H} or \textcircled{I} being selected, the view of \textcircled{H} or \textcircled{I} may be posed in Vimeo™ or uploaded to Youtube™.

The view of \textcircled{A} and \textcircled{B} of FIG. 12B are related to a photo content provider application region 1210 of FIG. 12C. In other words, different photos having the same data or the same location are displayed through a photo content provider application, and the metadata used for this is generated data and location information. In response to the selection of the user being presented, the region shifts to application or a web browser URL. \textcircled{C} of FIG. 12B is related to a third part photo effect application region 1211 of FIG. 12C. The third party photo effect application region 1211 represents effect photos applied through a third party photo effect application, and the used metadata is a title and file location information. \textcircled{D} of FIG. 12B corresponds to a third party music application region 1212 of FIG. 12C. The third party music application region 1212 uses metadata such as generated data and a location, and displays music provided through the metadata. \textcircled{E} and \textcircled{F} correspond to a third party social network service (SNS) (for example, Instagram™/Flickr™) region 1213 of FIG. 12C. For example, the third party SNS region 1213 displays a photo, description text having a hash tag, a tagged person, a Share key, or the like. The user may add a hash tag and a person to the photo and video, and designate share. The user may upload the photo and video on Flickr™. The used metadata is a title and a file location. \textcircled{H} and \textcircled{I} of FIG. 12B correspond to a third party video provider (for example, YouTube™/Vimeo™) region 1214 of FIG. 12C. The corresponding third party video provider region 1214 displays a video, a title, a description field, and a Post key. The used metadata is a title and a file location. \textcircled{G} of FIG. 12B corresponds to a third party map provider or a travel application (for example, Google™ map) region 1215 of FIG. 12C. The third party map provider or travel application region 1215 displays different photos of an uploaded location, a street view mode, and a map, and the metadata is located in the region.

The image display apparatus 100 as illustrated in FIG. 1 may provide an image related to a web browser to a unit screen 200 as illustrated in FIG. 12D. The related information related to the web browser image is displayed in a contextual view region 230. For example, in response to a news article being searched for by the user as illustrated in FIG. 12D, the third party manufacturer may provide the new article in a widget form using metadata related to a corresponding image. \textcircled{A} is a pocket application region, and provides scrapping service through a third party scrapping application. The user may read content of interest later through the pocket application service. An ADD key and three types of thumbnail images may be displayed in the pocket application region, and in response to the ADD key being pressed, newly added content is counted. The three types of thumbnails may include an article, a video, and an image. In response to the thumbnail image being selected, the pocket application is executed. The used metadata may be URL link information. \textcircled{B} is a flipboard application region, and provides rich site summary (RSS) reader service through a third party RSS reader. The user may subscribe to a web of interest. An upload key, an image, and about two lines of text information may be displayed in the flipboard application region. In response to a “subscribe” key being selected by the user, a new article recently added is displayed. The used metadata is URL link information. \textcircled{C} is a search engine region, and is related to a third party portal application. In response to a search bar being pressed to use another search engine, the user may view a search result without keyword input. In other words, a real time search result is displayed in the search engine region, and in response to the search result being selected, the region shifts to a corresponding search engine. The used metadata is URL link information.

The image display apparatus 100 as illustrated in FIG. 1 may provide an image related to music to a unit screen 200 as illustrated in element (a) of FIG. 12E. FIG. 12E illustrates a process of purchasing a concert ticket. The user may select and reproduce the music of John Mayer. The third party music application may provide various pieces of information and events for John Mayer to a contextual view region 230 as follows. For example, the third party music application may provide information for biography, all albums, Facebook™, a message updated to Twitter™, a high-ranked song list, a tour date, a music video, and a live video of an artist, similar artists, or the like. It can be seen that there is a concert in Seoul after two months in a process of searching for the tour date as illustrated in element (b) of FIG. 12E. The user may directly select a web/application link to reserve a ticket. The user may purchase the ticket through the above-described process as illustrated in element (c) of FIG. 12E.

The image display apparatus 100 as illustrated in FIG. 1 may display an image related to a file browser in a unit screen 200 as illustrated in FIG. 12F. A user opens a source, and finds a folder. A third party manufacturer may provide information related to folder metadata in a widget form. \textcircled{A} is a dropbox region, and provides a key so as to upload a folder of interest. The dropbox region displays a folder name and a user dropbox account. The used metadata is the folder name and the user dropbox account. \textcircled{B} is a region related to a file locking application (e.g., a file locker), and provides a locking function for the folder of interest and files in the folder. A text field of a passcode is displayed in the \textcircled{B} region. The used metadata is a file name and a file location. The locked folder may be displayed with a locking icon on the folder. Thumbnails of the files in the folder of interest are also displayed in the \textcircled{B} region. The used metadata is a file name, a file location, and a file thumbnail.

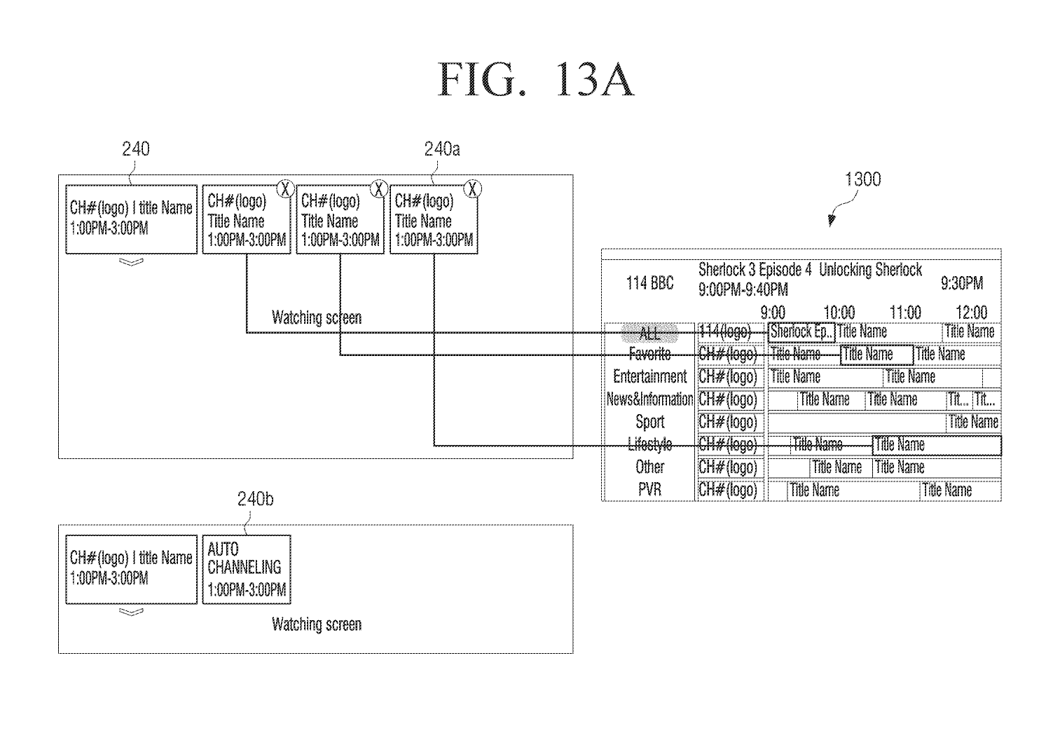

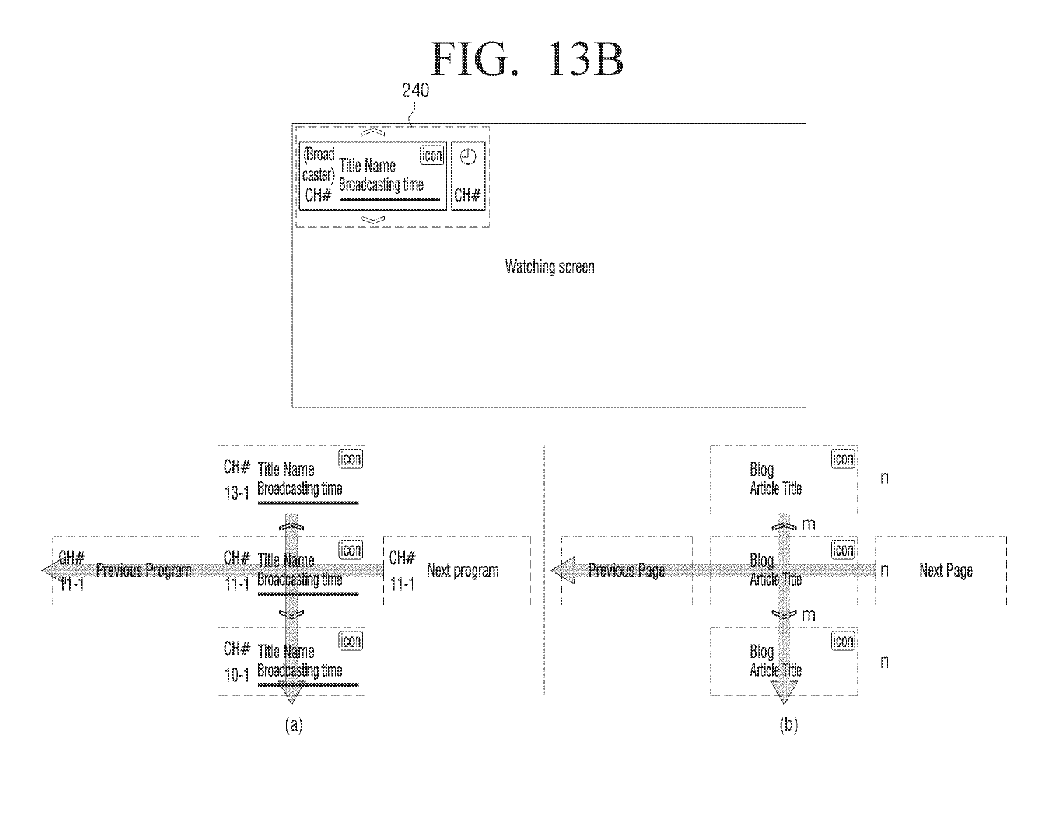

FIGS. 13A and 13B are views explaining a banner view region of FIG. 2 according to various embodiments of the present disclosure.

Referring to FIGS. 13A and 13B together with FIG. 1, in response to a user command for calling the banner view region being presented, the image display apparatus 100 may display reservation information 240a and auto channeling information 240b for a channel selected on an EPG table 1300 through a reservation watching view in a banner view region 240. The auto channeling may analyze a viewing pattern of the user, for example, hourly log data, and in response to the user favorite channel being broadcasted at a corresponding time, the broadcasting of the corresponding user favorite channel may be automatically provided through the auto channeling. In response to the auto channeling being set, the auto channeling may change the channel to the watchable channel of the user, and provide the broadcasting of the watchable channel without the separate channel zapping.

A view navigation function in a view set designated by the user is provided in the banner view region 240. The banner view region 240 displays representative information of each view such as a channel name and a channel number. For example, the channel information may be provided to the banner view region 240 as illustrated in element (a) of FIG. 13B, and information using a RSS reader application such as a blog may be provided as illustrated in element (b) of FIG. 13B. In response to the UP/DOWN keys being controlled among the directional keys, the channel name may be changed, and in response to the LEFT/RIGHT keys being controlled among the directional keys, information for programs of a previous time zone and next time zone in the same channel may be displayed. The control through the directional keys may be applied to the blog.

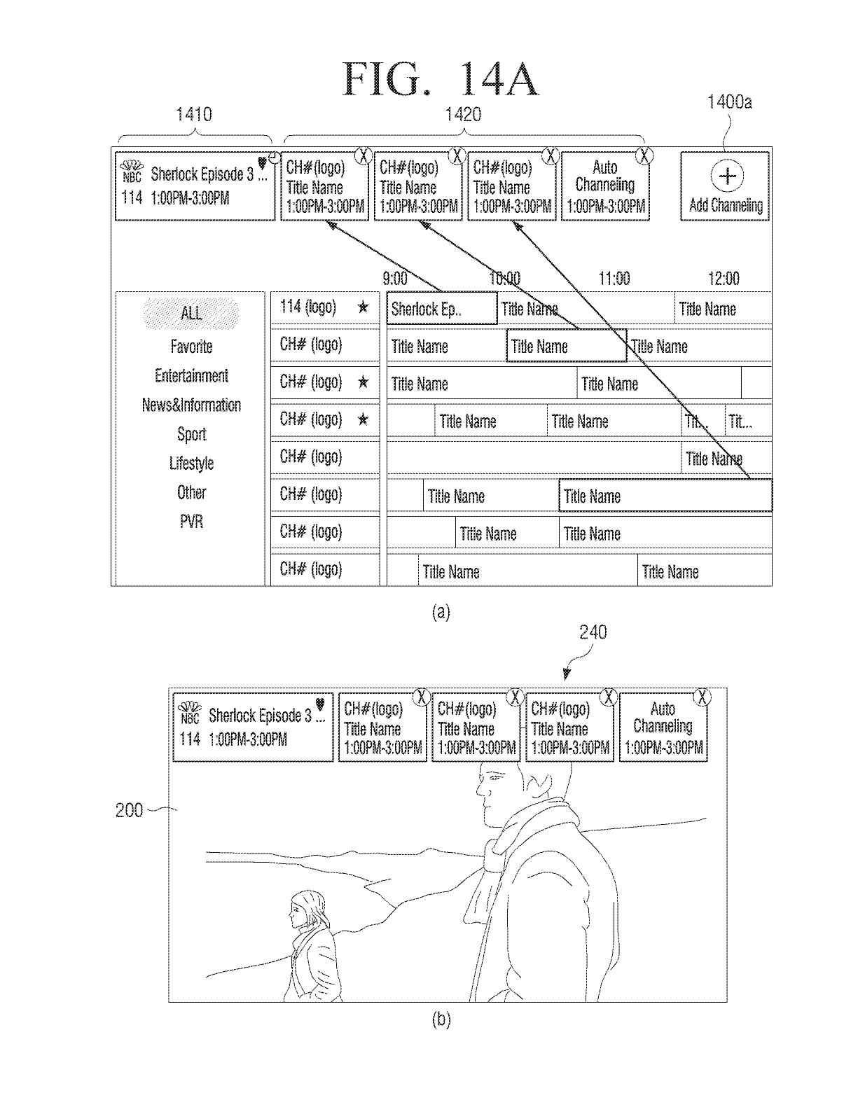

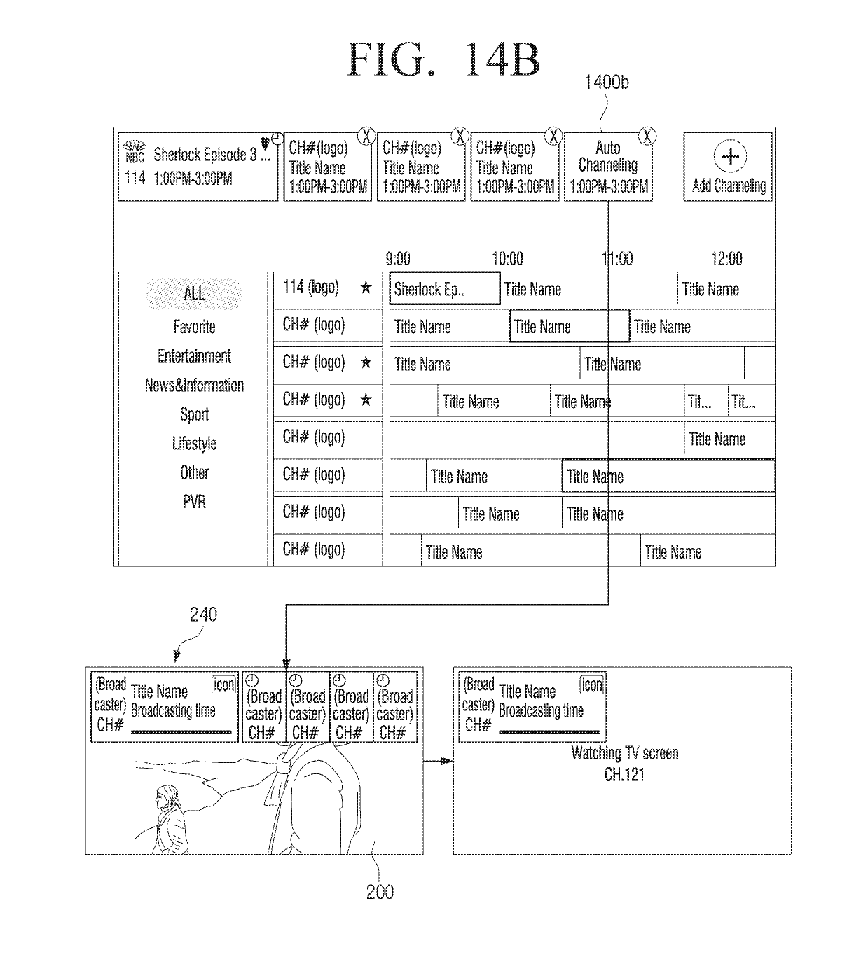

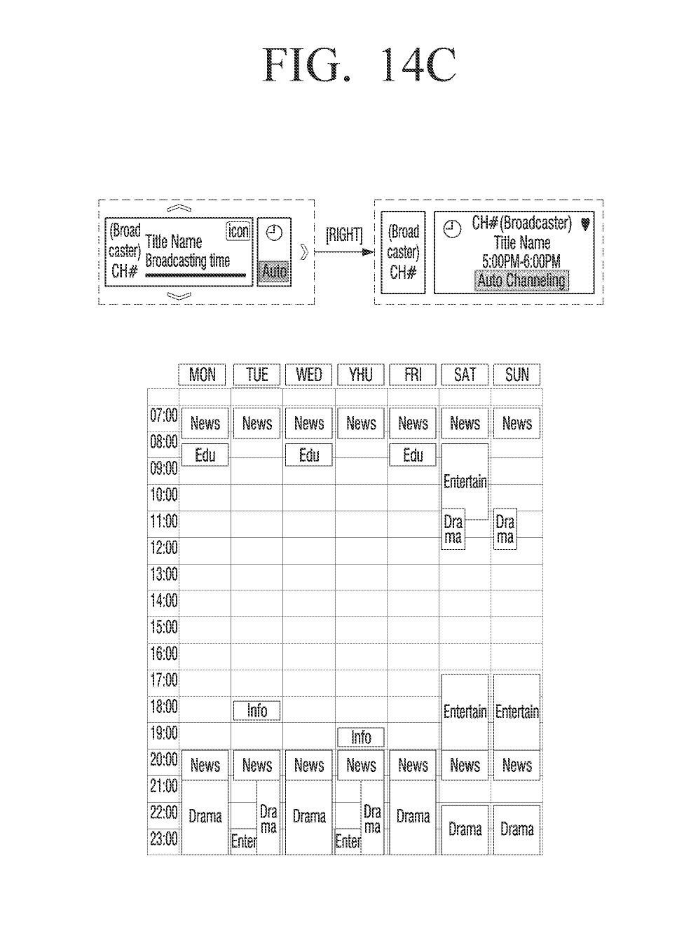

FIGS. 14A, 14B, and 14C are views explaining watching reservation information displayed in a banner view region of FIG. 2 according to various embodiments of the present disclosure.

Referring to FIG. 14A, a user may set a desired broadcasting program in a banner view region 240, as illustrated in element (b) of FIG. 14A. In other words, the user may display a channel selected through the reservation watching view on the EPG in the banner view region 240, and delete and manage the channel in the banner view region 240. In response to the desired program being selected, a reservation status is represented in an upper stage (or upper region) of the banner view region 240, and the desired program is added from the left to the right of the selected reservation program in preferential time order. The reserved program may be deleted by a DELETE key, and in response to the reserved channel region being selected, the banner view region 240 may shift to a detailed screen of the corresponding program.

Reference numeral 1410 as illustrated in element (a) of FIG. 14A denotes channel information for a currently watching program, reference numeral 1420 denotes channel information of the reserved program and reference numeral 1400a denotes add channeling. The auto channeling information may be included in the channel information of the reserved program. Element (b) as illustrated in FIG. 14A shows that the banner view region 240 is displayed to overlap the unit screen 200 according to a user command for calling the banner view region 240.

The image display apparatus 100 of FIG. 1 displays auto channeling information 1400b in a banner view region 240, which overlaps a unit screen 200, as illustrated in FIG. 14B. The image display apparatus 100 extracts a daily program periodically or regularly viewed through a viewing pattern of the user, and provides the extracted daily program through the auto channeling. For example, in the auto channeling, the image display apparatus 100 may record the log for a program and channel executed by the user at a corresponding time of a corresponding day based on the day and time as illustrated in FIG. 14C, pattern the item having the highest frequency, for example, the program and channel, and store the patterning result. In response to the auto channeling being selected, an item matching with a corresponding condition, that is, a registered channeling item, a day, and a time broadcasting context is automatically executed, and sequentially broadcasted without an action of the user.

Through the above-described configuration, use learning is increased due to a simple structure of a screen unit, and convenience is increased through recommendation of the related information or function based on the user circumstances. Further, consumption behavior of content is not broken, and thus simultaneous preview of various items may be possible.

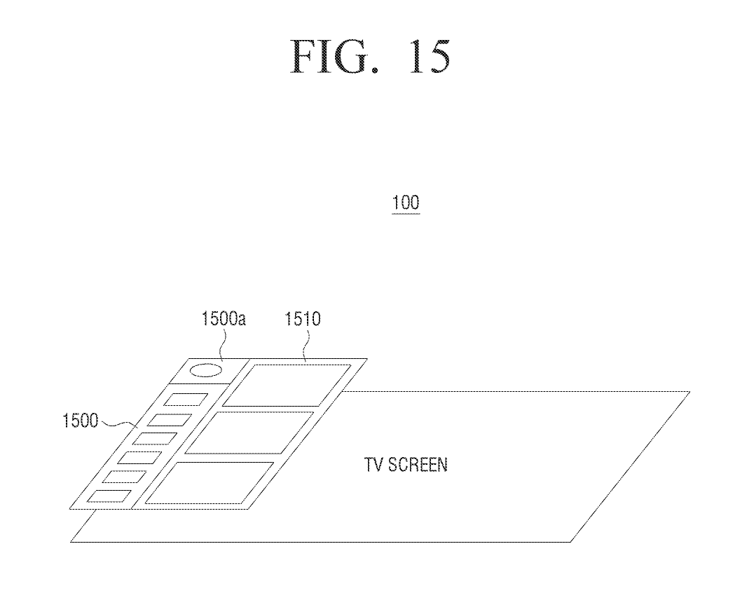

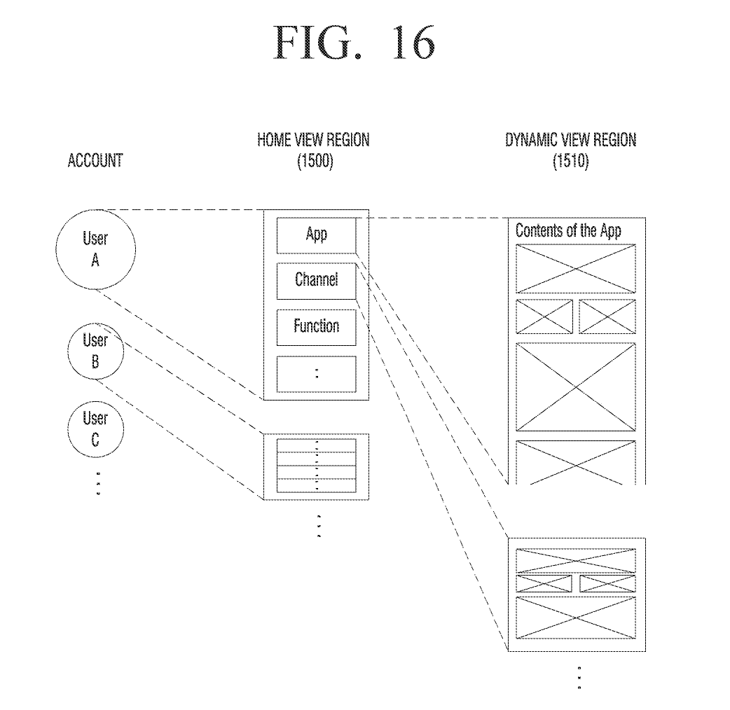

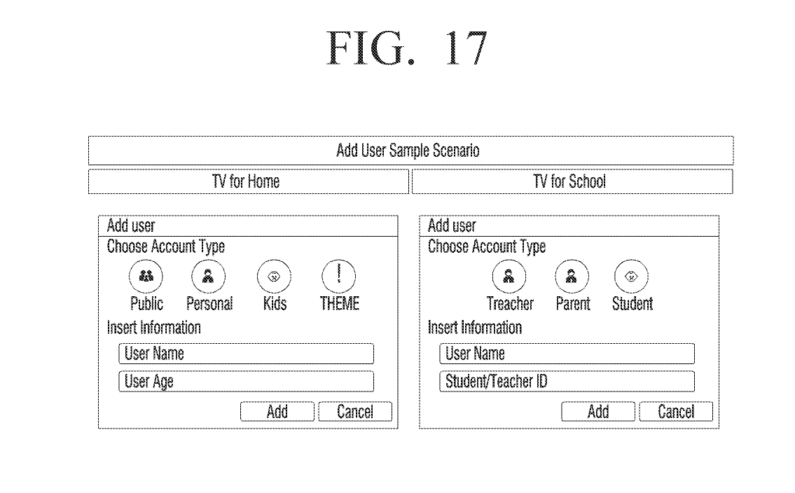

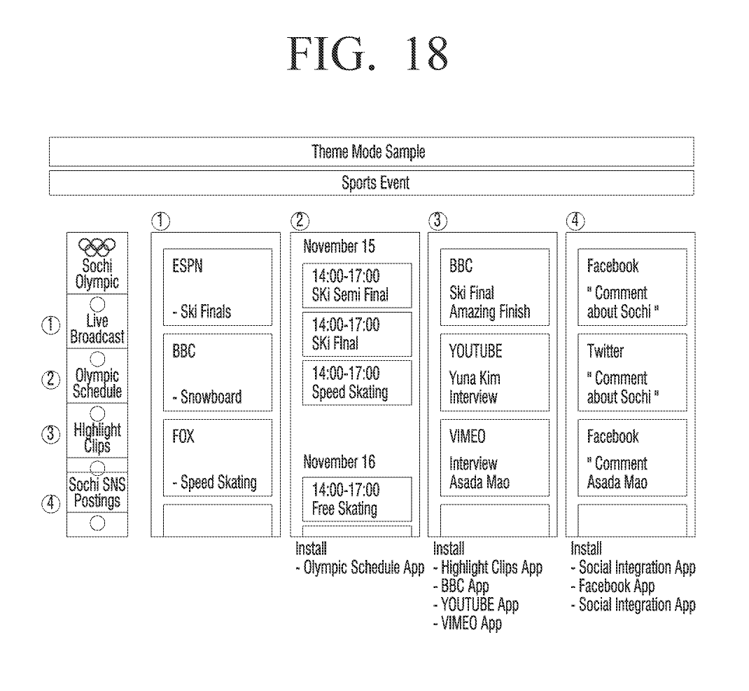

FIG. 15 is a view explaining an account-based personalized home screen according to an embodiment of the present disclosure, FIG. 16 is a view explaining an overall structure of a home view region and a dynamic view region according to an embodiment of the present disclosure, and FIG. 17 is a view illustrating an account creation example according to an embodiment of the present disclosure. FIG. 18 is an illustrative view illustrating a home view region and a dynamic view region in a Theme mode account of FIG. 17 according to an embodiment of the present disclosure.

For clarity, referring to FIGS. 15 and 16 together with FIG. 1, an image display apparatus 100 simultaneously displays a home view region 1500 and a dynamic view region 1510 on a unit screen according to a user command for calling the home view region 1500.

The home view region 1500 may be formed of two layers. For example, the home view region 1500 displayed according to the user command may be a region including execution icons provided as default by a TV manufacturer. An account icon 1500a which can create and select an account according to the user may be added to the home view region 1500. The new user-based home view region 1500 and the new user-based dynamic view region 1510 may be displayed according to the selection of the account icon 1500a.

Referring to FIG. 16, the home view region 1500 and the dynamic view region 1510 may be configured based on different user accounts.

In connection with the setting of the user account, as illustrated in FIG. 15, an account creation method may be variously set according to the user environment. For example, the account creation method may be changed even in a TV according to whether or not the TV is a home device or a public device. It may be possible to filter pieces of content of the home view region 1500 and the dynamic view region 1510 through information input in the account creation.

Referring to FIG. 17, which illustrates an example of an account creation screen, “Public” is a public account provided in response to the account being used regardless of the user classification, and “Personal” is a basic personal account, and may set a name, a photo, a password, or the like. “Kids Mode” is a child mode, and may additionally set an age. In response to the age being set in “Kids mode” being set, content unsuitable for the corresponding age may be automatically blocked. “Theme mode” specialized to a specific event such as World Cup or Olympics may be set. “Theme mode” may be provided from an apparatus such as a content provider or an operating system (OS).

The manufacturer may set “Theme Mode” with an item of the home view region 1500 in advance. In response to a specific event account being created, all preset applications may be collectively installed as illustrated in FIG. 18. Further, a mode for a business to business (B2B) customer may be set. For example, a mode specialized to B2B such as a library, a hotel, or a school may be set.

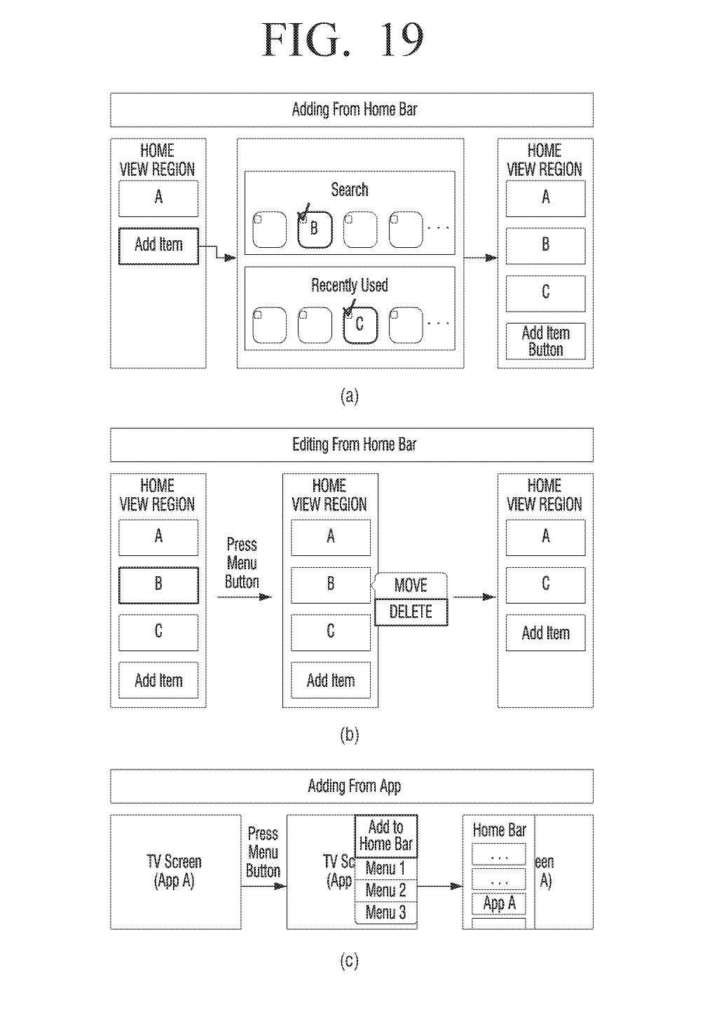

FIGS. 19, 20, 21, 22, 23, 24A, 25A, 25B, and 25C are views explaining use of a home view region and a dynamic view region of FIG. 15 according to various embodiments of the present disclosure.

FIG. 19 illustrates a flow for setting or editing an item in the home view region 1500 as illustrated in FIG. 15, and for example, a portion desired by the user among an application, a source, and a function in a TV may be arranged. A live TV may be individual broadcast or a bundle of broadcasts, and the application may be an individual application, content in an application, or a function in an application. The source may be an individual source or a bundle of sources. The setup of the home view region 1500 is attributed to an account selected in the home screen, that is, the unit screen.

To add an item to the home view region 1500, as illustrated in element (a) of FIG. 19, an Add Item key may be selected, information objects B and C may be selected, and thus the items B and C may be added onto the home view region 1500.

In response to deletion being necessary, as illustrated in element (b) of FIG. 19, the corresponding item B may be selected, a DELETE key may be selected, and thus the item B may be simply deleted.

According to an embodiment of the present disclosure, the image display apparatus 100 of FIG. 1 may set the item in application units or in content or function units in the application as illustrated in element (c) of FIG. 19.

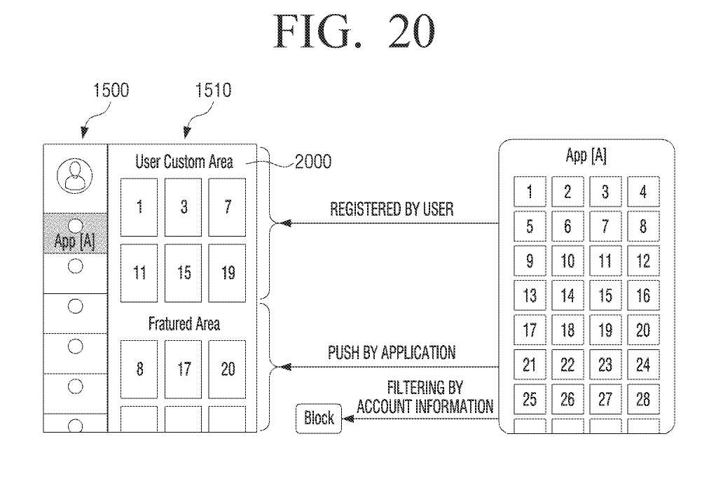

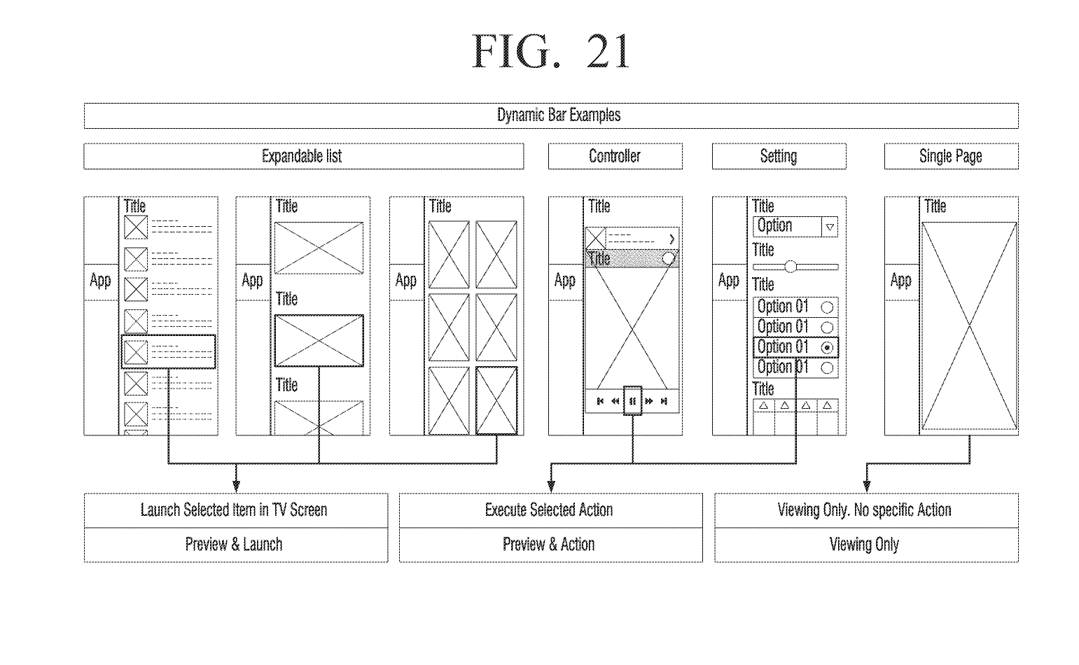

FIG. 20 is a view illustrating a method of adding an item to the dynamic view region 1510 of FIG. 15, and FIG. 21 is an illustrative view illustrating various types of dynamic view regions according to an embodiment of the present disclosure.

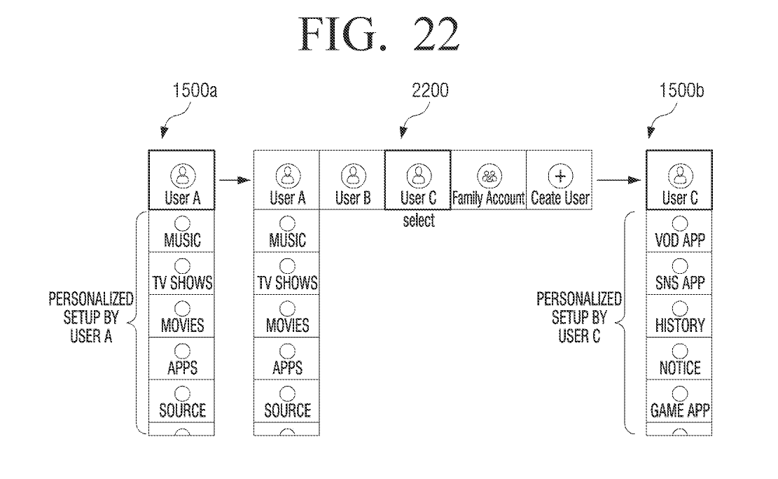

Referring to FIGS. 20 and 21, the dynamic view region 1510 of FIG. 15 corresponds to a region for preview of items in the home view region 1500. The items arranged in the dynamic view region 1510 may be different according to an application policy. In FIG. 20, a category of a user customer region 2000 may be defined by an application. An information object in the dynamic view region 1510 may be registered by the user, and may be pushed through a related application. The pushed information object may be filtered according to account information such as a child mode or a student mode. Also, according to an embodiment of the present disclosure, a type among various types of title arrangement examples (an expandable list, a single page) illustrated in FIG. 21 may be selected and a screen may be configured according to the selected type, and also a screen may be configured to be able to use a controller or an option setting of a selected specific title. FIGS. 22, 23 and 24 are views illustrating a process of activating a personal setting in the home view region of FIG. 15.

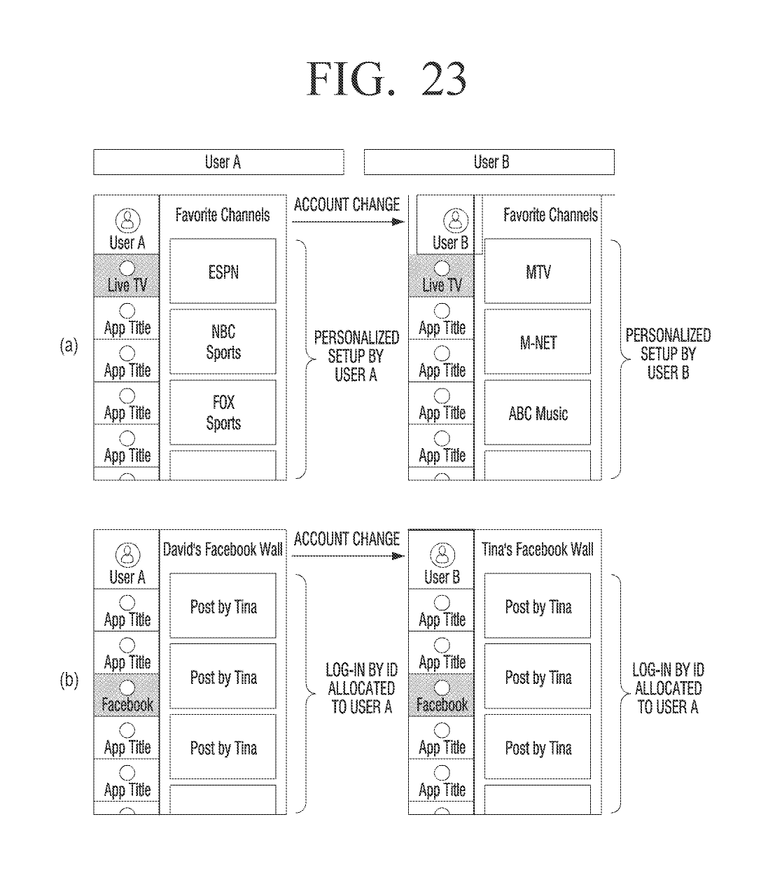

FIG. 22 is an illustrative view illustrating setting activation of a home view region according to account change. First, the image display apparatus 100 of FIG. 15 may be in the state in which the home view region 1500 is changed to a personalized home view region 1500a with respect to a user A as illustrated in FIG. 22. In other words, the account icon 1500a located in an upper stage of the home view region 1500 of FIG. 15 may be selected in the home view region 1500, and an account of the user A is selected in a user account region 2210 displayed in an upper region of the region as illustrated in FIG. 23, and therefore, the screen state may be obtained as illustrated in FIG. 22.

Then, in response to the account of the user A being selected again in FIG. 22, a user account region 2200 may be displayed in the upper region of the screen. In the response to a specific account, that is, an account of a user C being selected in the user account region 2200, the user A-personalized home view region 1500a displayed may be changed to a user C-personalized home view region 1500b.

FIG. 23 is a view illustrating setting activation of a dynamic view region according to account change according to an embodiment of the present disclosure.

Referring to element (a) of FIG. 23, dynamic view regions of the user A and the user B are differently set according to the users.

Referring to element (b) of FIG. 23, the user A and the user B log in through IDs allocated to the users A and B, and enter their home view regions.

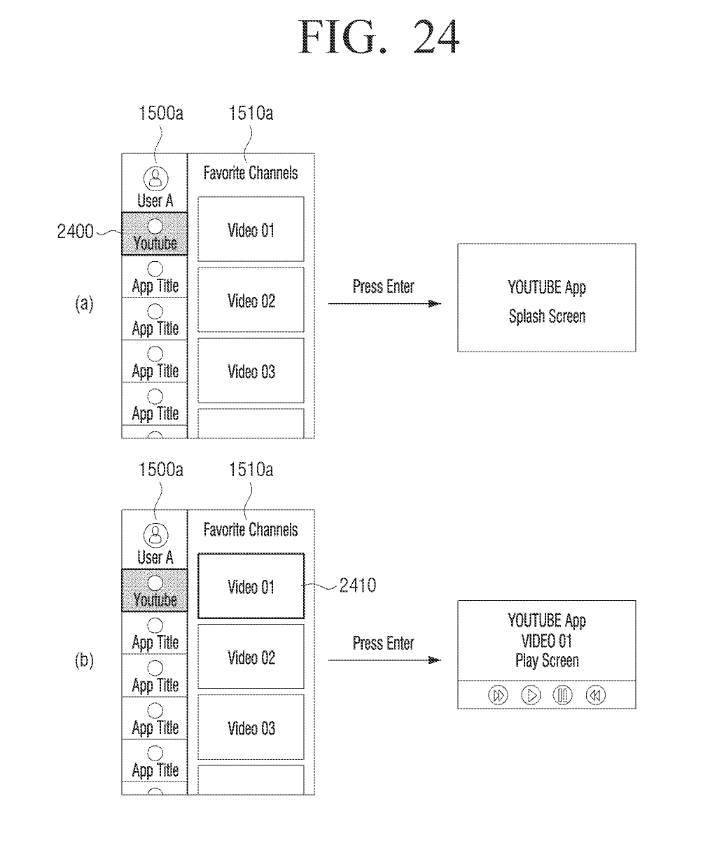

FIG. 24 is a view illustrating a process of activating setting item execution process of a home view region and a dynamic view region according to an embodiment of the present disclosure.

For example, as illustrated in element (a) of FIG. 24, in response to an execution icon 2400 corresponding to Youtube™ displayed in a home view region 1500a being selected, it may be regarded that an application corresponding to the Youtube™ is executed.

As illustrated in element (b) of FIG. 24, in response to a video 1 2410 displayed in the dynamic view region 1510a being selected, it may be regarded that an application associated with the corresponding video 1 2410 is executed. In response to the application being executed in the home view region 1500a, it may be possible to enter a first screen (for example, splash screen) of the application, and in response to the application being executed in the dynamic view region 1500b, it may be possible to directly access to corresponding content or function in the dynamic view region 1500b.

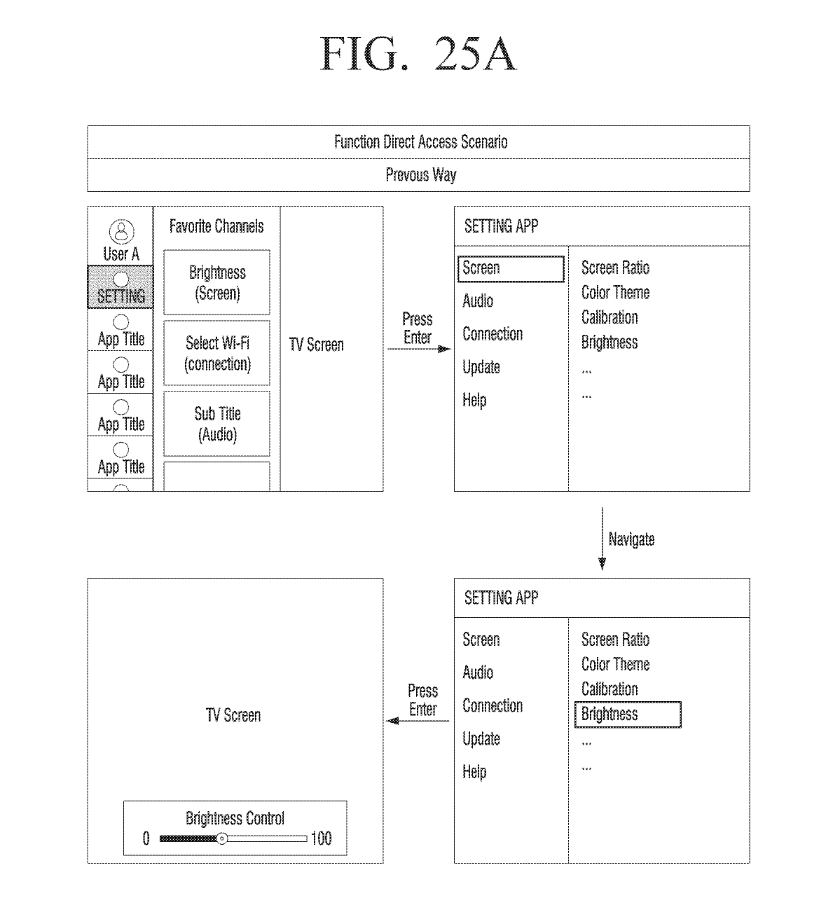

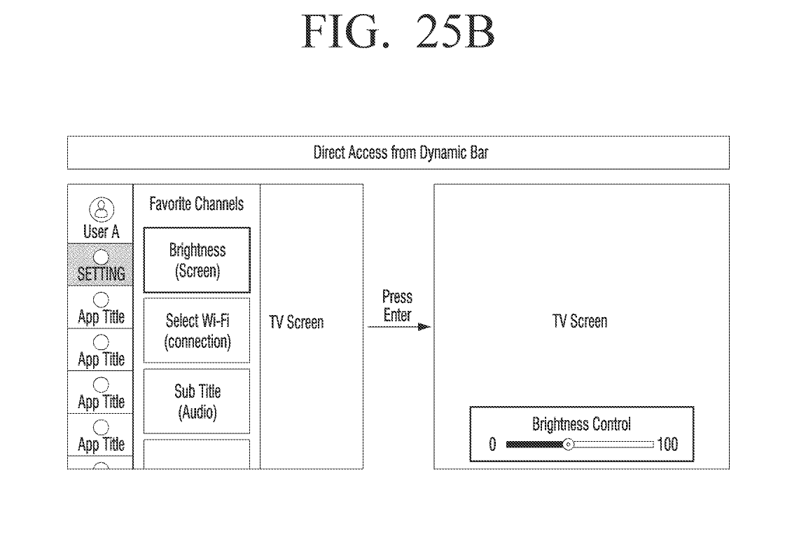

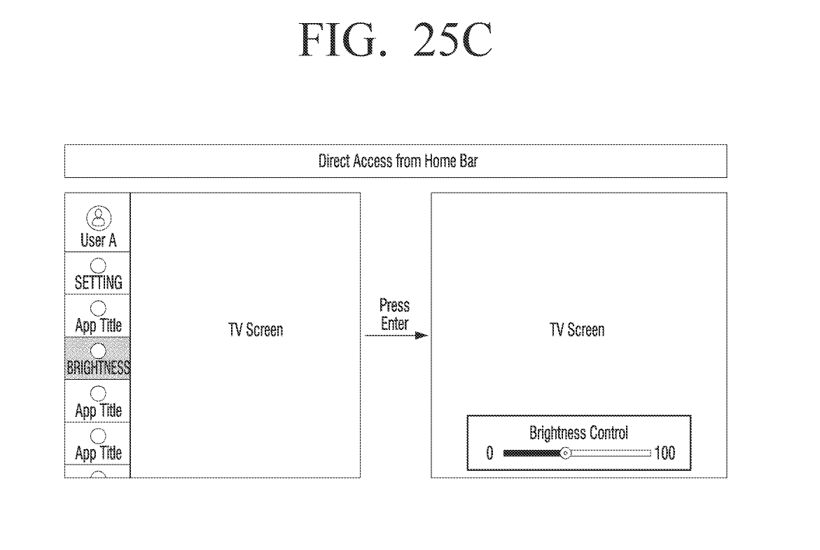

FIGS. 25A, 25B, and 25C are illustrative views illustrating a setting item execution process of a home view region and a dynamic view region according to various embodiments of the present disclosure.

Referring to FIGS. 25B and 25C, after an image display apparatus registers a frequently used item in a home view region and a dynamic view region, the image display apparatus may select a specific execution icon of the home view region or an information object of the dynamic view region, and thus directly access the corresponding item, other than a method of finding and entering the item one by one to set “Brightness” as illustrated in FIG. 25A.

Through the above-described configuration, the account is linked with the arrangement of the application or widget of the home view region as well as to the internal setup, the filtering through additional information of the users is provided, and thus personalization through account-based linkage may be possible. The desired item is arranged in the uppermost stage through the dynamic view region, the entire UI is configured of content limited to a specific theme through the theme mode, and thus a content provider or an application developer may directly transmit content to the user.

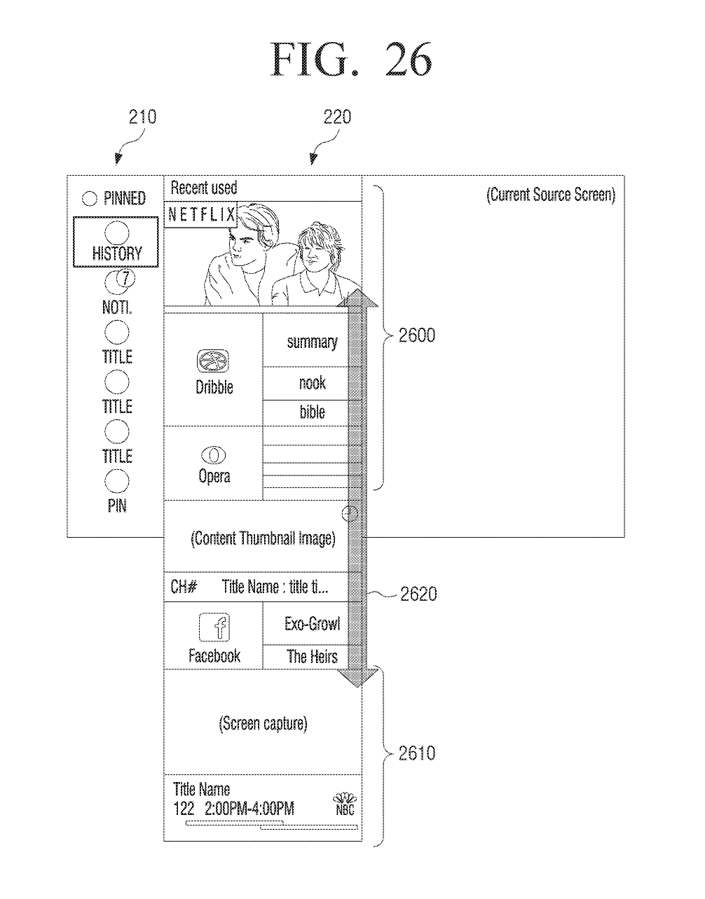

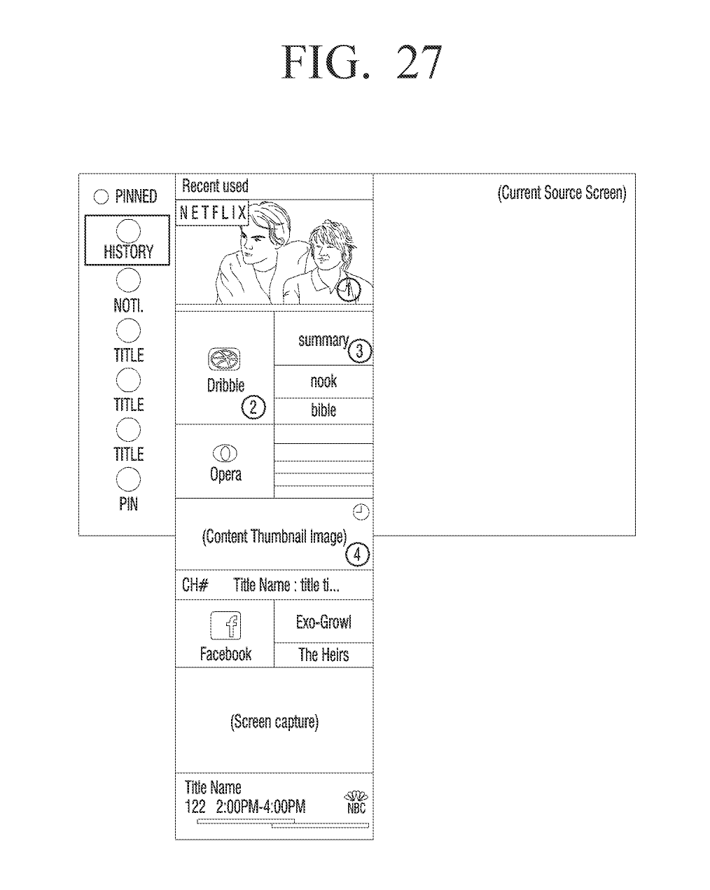

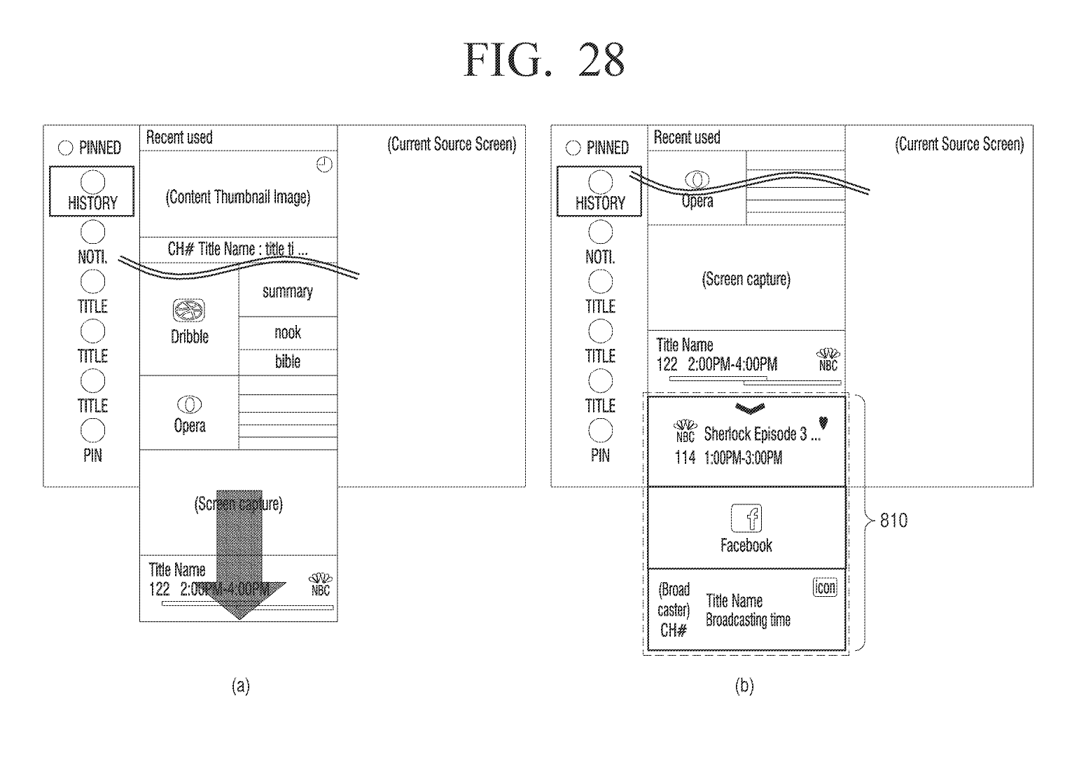

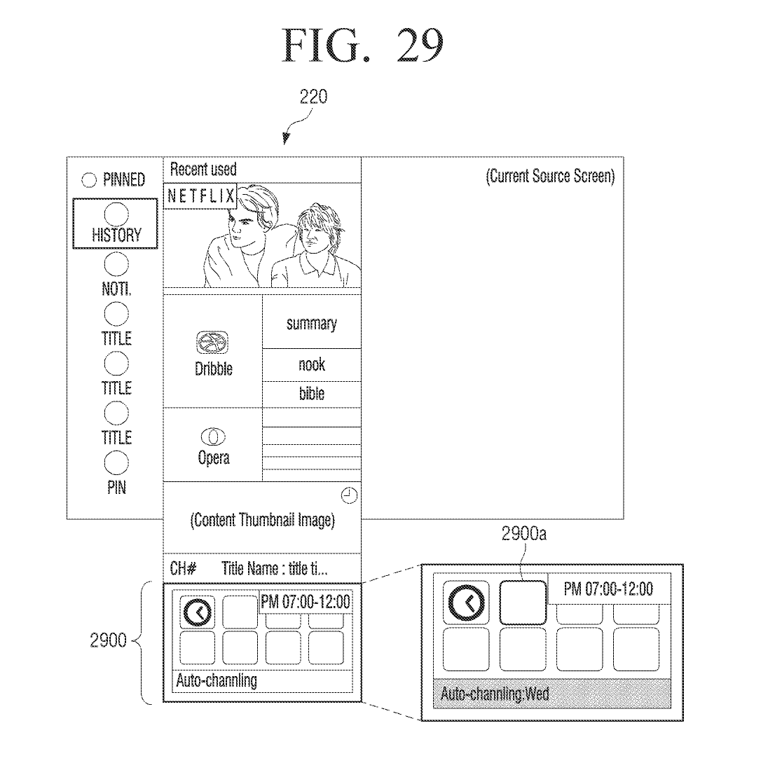

FIG. 26 is a view illustrating an example of a configuration and operation of a dynamic view region according to an embodiment of the present disclosure, and FIG. 27 is a view explaining an information object displayed in a dynamic view region according to an embodiment of the present disclosure. FIG. 28 is a view explaining a recommendation of an information object to a dynamic view region according to an embodiment of the present disclosure, and FIG. 29 is a view explaining a process of displaying a history of an auto channel in a dynamic view region according to an embodiment of the present disclosure.

For clarity, referring to FIG. 26 together with FIGS. 1, 8 and 9, the image display apparatus 100 of FIG. 1 according to an embodiment of the present disclosure may display a home view region 210 and a dynamic view region 220 according to a user command, allow a highlight to be located in an execution icon corresponding to a HISTORY, and thus display the dynamic view region 220 as illustrated in FIG. 26.

The dynamic view region 220 includes a first region 2600 and a second region 2610. The first region 2600 and the second region 2610 are configured of a minimum unit for displaying an operation performed according to the user intention and an application, a channel, and a program as representation of the operation. In an embodiment of the present disclosure, the first and second regions 2600 and 2610 may be called an info-banner. It may be regarded that the history configuration of the dynamic view region 220 may be configured in units of currently used info-banner. The second region 2610 corresponds to an info-banner of an application, a channel, or a program which is currently watching, is currently used, or is finally executed.

A broadcasting program, a specific channel, and an application which are recently watched by the user are displayed in an info-banner form in time order in the history, and thus allow the user to easily fast access to the desired item. The image display apparatus 100 may provide a history log used for a week according to up/down of a scroll 2620. Further, an info-banner which is finally executed or is currently used may be displayed in a lowermost stage of a region viewed in entering of the history. The user performs scroll-up upward so as to view a desired previous info-banner log.

Referring to FIG. 27, \textcircled{1} represents a recent channel among info-banner types. The image display apparatus may enter the corresponding channel, and enter a web page of the channel or a VOD main page in the state in which broadcasting of the corresponding channel is ended. Further, \textcircled{2} and \textcircled{3} represent a recent application and content among the info-banner types, and in response to an application being selected, \textcircled{2} enters the corresponding application and activate the corresponding application. Moreover, \textcircled{2} enters the operating application state in response to the application being opened. Also, \textcircled{3} may directly enter the application state including corresponding content in response to the content being selected. For example, in response to calling and “Hong Gil-dong”, it may be possible to make a call to a contact of “Hong Gil-dong”. \textcircled{4} is related to a recent program among the info-banner types. \textcircled{4} directly connects to the corresponding program in response to a corresponding broadcasting program being reproduced, or \textcircled{4} connects to VOD service of the corresponding program in response to the corresponding program being not broadcasted.

In response to the scrolling down being performed in element (a) of FIG. 28, a screen as illustrated in element (b) of FIG. 28 may be displayed. As described above in FIG. 8, a user log-based recommendation info-banner 810 may be provided. In other words, the scrolling down being further performed toward a lower stage of the info-banner of an application, a program, or a channel which is most recently executed, the program, application or channel which are most watchable to the user in a current state may be recommended one by one based on content (for example, day, time zone, use frequency, or the like)-based current log analysis, and thus the user's desired intention may be fast easily accessed and performed. In response to the scrolling up being performed upward without separation selection, the recommendation info-banner disappears.

As illustrated in FIG. 29, in response to an auto channeling function being set by a user, the image display apparatus 100 of FIG. 1 displays the latest info-banner 2900 in a dynamic view region 220 through the auto channeling. Thumbnail images of programs that can be provided through the auto channeling may be displayed in the dynamic view region 220, and the auto channeling providing time and date may be displayed in the info-banner. Reference numeral 2900a denotes a program which is to be selected through the auto channeling and reservation-reproduced.

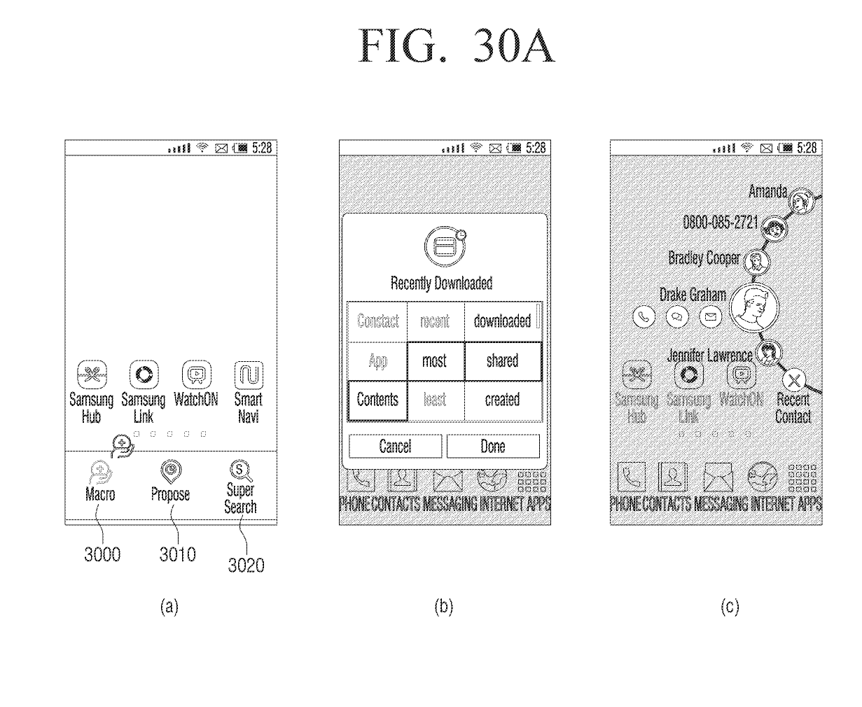

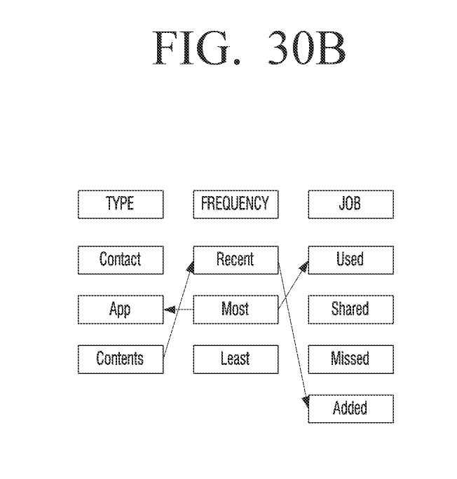

FIG. 30A is a view explaining a variable icon of which a function is changed according to a use context according to an embodiment of the present disclosure, and FIG. 30B is a view re-illustrating a key pad portion of element (b) of FIG. 30A.

Referring to FIGS. 30A and 30B, the image display apparatus 100 of FIG. 1 according to an embodiment of the present disclosure, for example, such as a smart phone, may include execution keys 3000, 3010, and 3020, as illustrated in element (a) of FIG. 30A, configured to create a macro icon, a propose icon, and a search icon in a lower portion of a home screen. The execution key 3000 configured to create the macro icon is related to designation of frequency and an operation of an item to be accessed and creation of a shortcut. The execution key 3010 configured to create the propose icon is related to visualization of stay places of the user according to times through clustering, and recommendation and provision of frequently used applications according to context in entering of a corresponding map. The execution icon 3020 configured to create the search icon is related to transmission of a category search word to an application and display of a searching result, and to designation of the search word and a target application in a package and fast and easy access to desired information through the application.

For example, the user sets whether the macro icon has to be changed in any condition so as to vary the macro icon. For this, the user selects an ADD (+) key on the execution key 3000 configured to create the macro icon on a home screen illustrated in element (a) of FIG. 30A. The user selects one among three items of Contact, App, and Contents in a screen illustrated in element (b) of FIG. 30A displayed next to the home screen illustrated in element (a) of FIG. 30A, and sequentially selects the frequency and job for the selected item in order.

For example, as illustrated in element (b) of FIG. 30A as well as FIG. 30B, Contents, Most, and Shared may be designated as the type, frequency, and job, respectively. Then, the user selects a Done key in a lower stage of the screen. Therefore, the setup of varying the macro icon is completed. In response to a macro icon created later being selected again, a shortcut to a screen illustrated in element (c) of FIG. 30C may be possible, and icons are created, arranged, and displayed according to the previously set condition as illustrated in element (c) of FIG. 30A. A specific icon created and arranged is long pressed, and a navigation operation may be further performed.

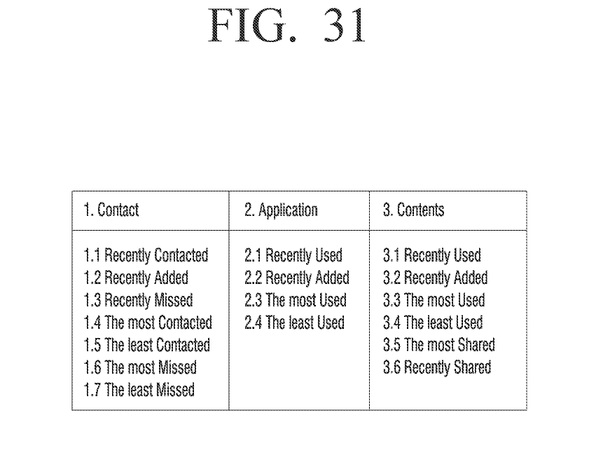

FIG. 31 is a view explaining an attribute for creating a macro icon in a home screen according to an embodiment of the present disclosure.

Referring to FIG. 31, attributes for creating macro icons may be represented as, for example, through “Recently Added+Contents”, the latest generated (or downloaded) file is automatically connected, and thus the user may directly access to the file just previously downloaded without calling of files downloaded through a file browser or the like. The user may easily access to the most favorite contact through “Most Contacted+Contact”. In response to the macro icon having the “Recently Used+Application” attribute being created, the user may fast access to the latest executed applications. The table illustrated in FIG. 31 is merely an example suggested as a macro icon creating method, and may be constructed through different various methods.

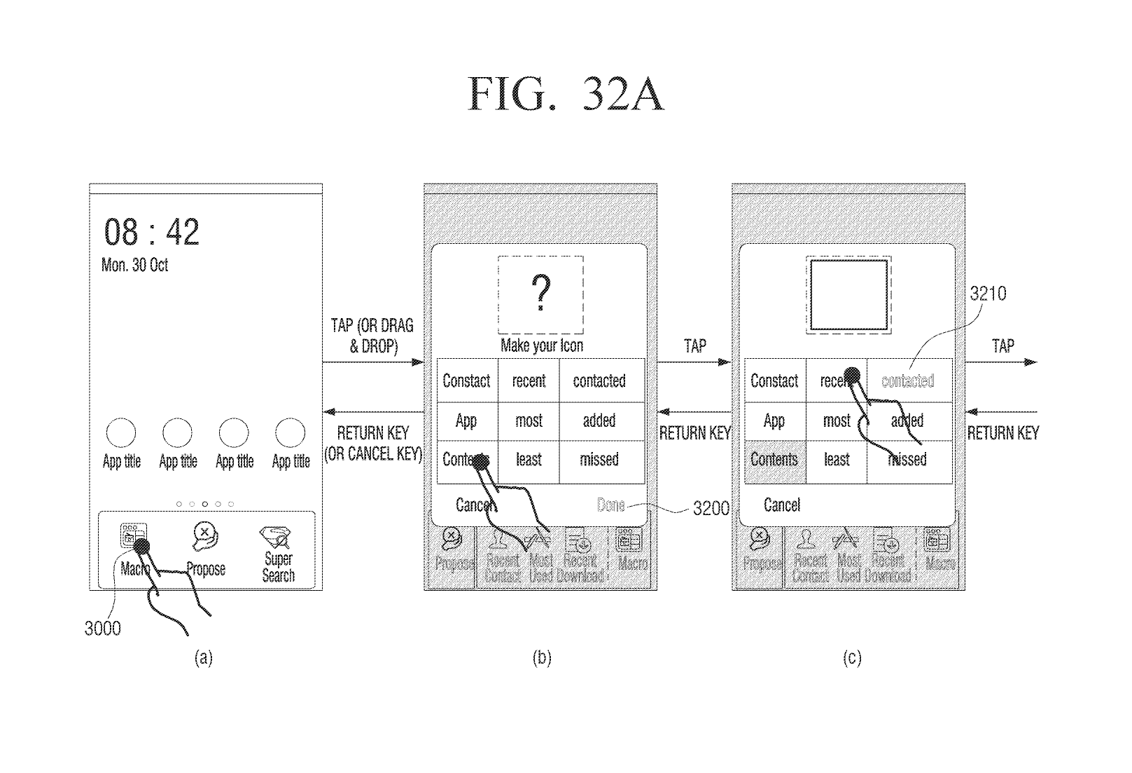

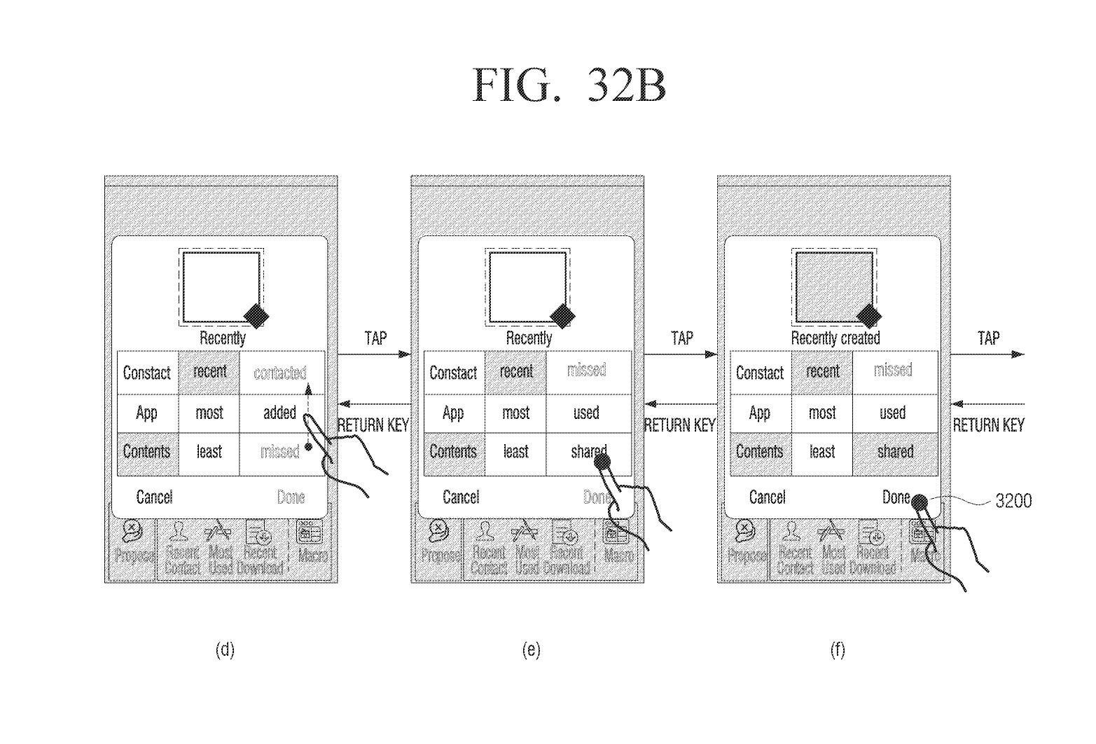

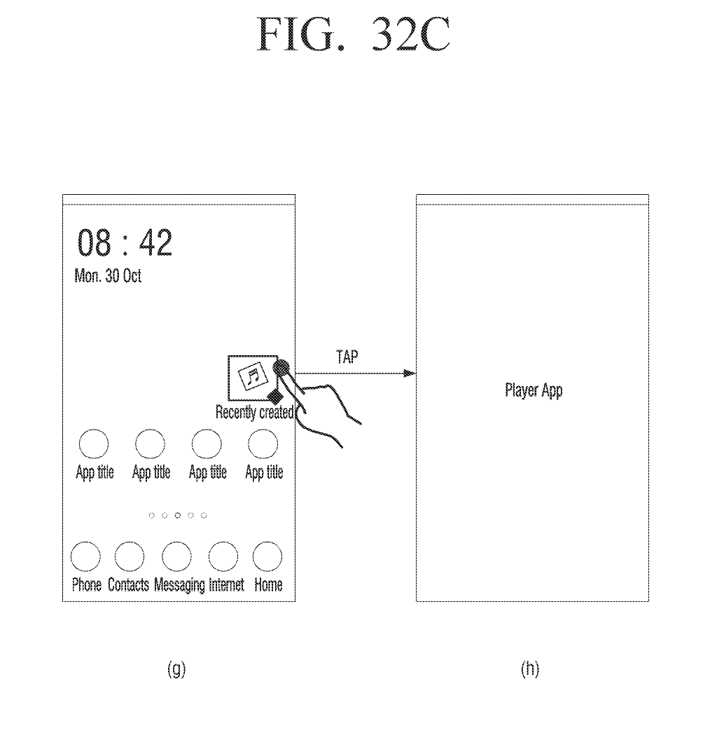

FIGS. 32A, 32B, and 32C are detailed views illustrating a process of setting a condition for varying the macro icon of FIGS. 30A and 30B according to various embodiments of the present disclosure.

As illustrated in element (a) of FIG. 32A, in response to an execution key 3000 configured to create the macro icon being selected or being dragged to a home screen by the user in a screen, a setup screen as illustrated in element (b) of FIG. 32A is displayed. The subject, condition, and action in order are selected in the displayed setting screen. The subject, condition, and action may be selected in reverse order. A Done key 3200 may be dimly displayed in the state in which the setup is not completed. In response to the subject being not presented in the upper side as illustrated in element (c) of FIG. 32A, a contacted key 3210 may also be dimly displayed.

The user may set the type and frequency through elements (b) and (c) of FIG. 32A), and then the user may finally set the job through a scroll operation, or the like as illustrated in elements (d) and (e) of FIG. 32B. In response to the setup for the job being completed, the Done key 3200 is activated as illustrated in element (f) of FIG. 32B. In response to the corresponding Done key 3200 being selected, the setup is completed. In response to the setup being completed, attribute values for corresponding icons are reflected to corresponding icons and the corresponding icons are arranged in the home screen as illustrated in element (g) of FIG. 32C. Then, the user may enter a corresponding screen or execute an application according to an icon tapped in element (g) of FIG. 32C, as illustrated by element (h) of FIG. 32C.

Whenever the type, frequency, and job are set as described above, the preview is a concept of a layer, attribute values may be previewed one by one in the home screen, the condition and action of an application to be set as description may be provided with text in a lower stage of the home screen. The subject and condition may be fixed, but all the actions such as Contacted, added, missed, used, and shared may be included in one set, and thus the selection may be performed through a scroll operation. A return key (or a cancel key) is selected in each screen, and in response to a previous screen being presented, the screen returns to the previous screen.

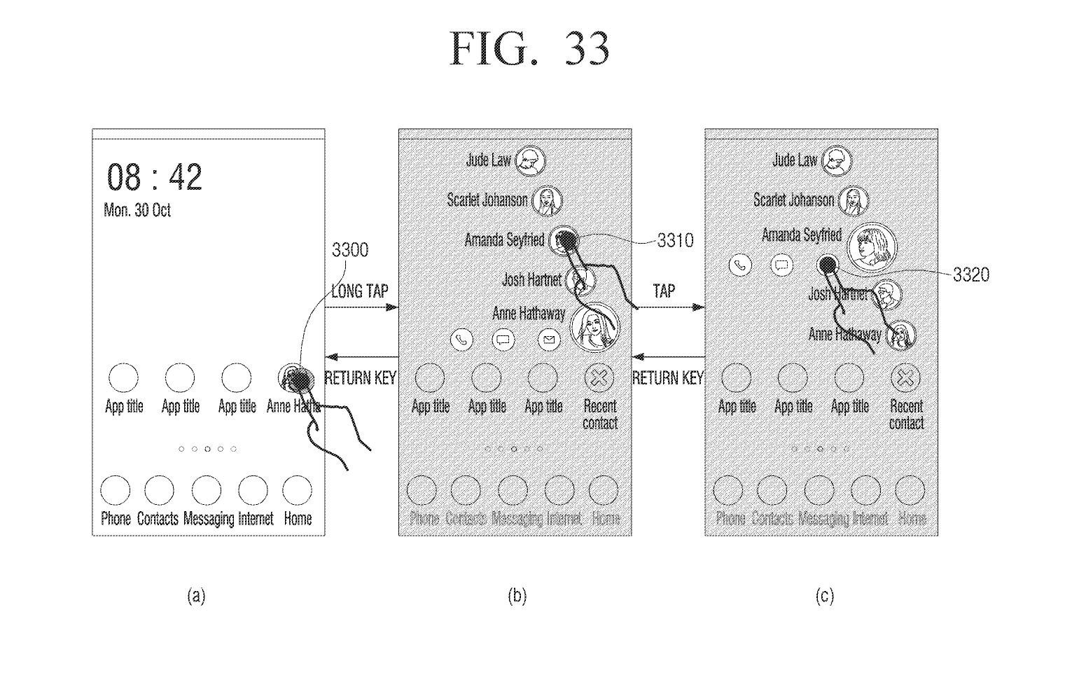

FIG. 33 is a view explaining a shortcut to a history screen through a macro icon created in a home screen according to an embodiment of the present disclosure.

Though a series of processes as illustrated in FIGS. 32A to 32C, a macro icon 3300 having a Recent Contact attribute may be created in a home screen as illustrated in element (a) of FIG. 33. Subsequently, the user may select the corresponding macro icon 3300, and view a history recently contacted at a glance as illustrated in elements (b) and (c) of FIG. 33. A specific user 3310 represented with a thumbnail image is selected in element (b) of FIG. 33, and conversion to a screen as illustrated in element (c) of FIG. 33 is performed. The user may select a message key 3320 displayed on the screen and check message contents. For example, in response to the specific user 3310 being selected in element (b) of FIG. 33, a size of an icon tapped as illustrated in element (c) FIG. 33 is expanded, and a contact path menu and detailed information are provided.

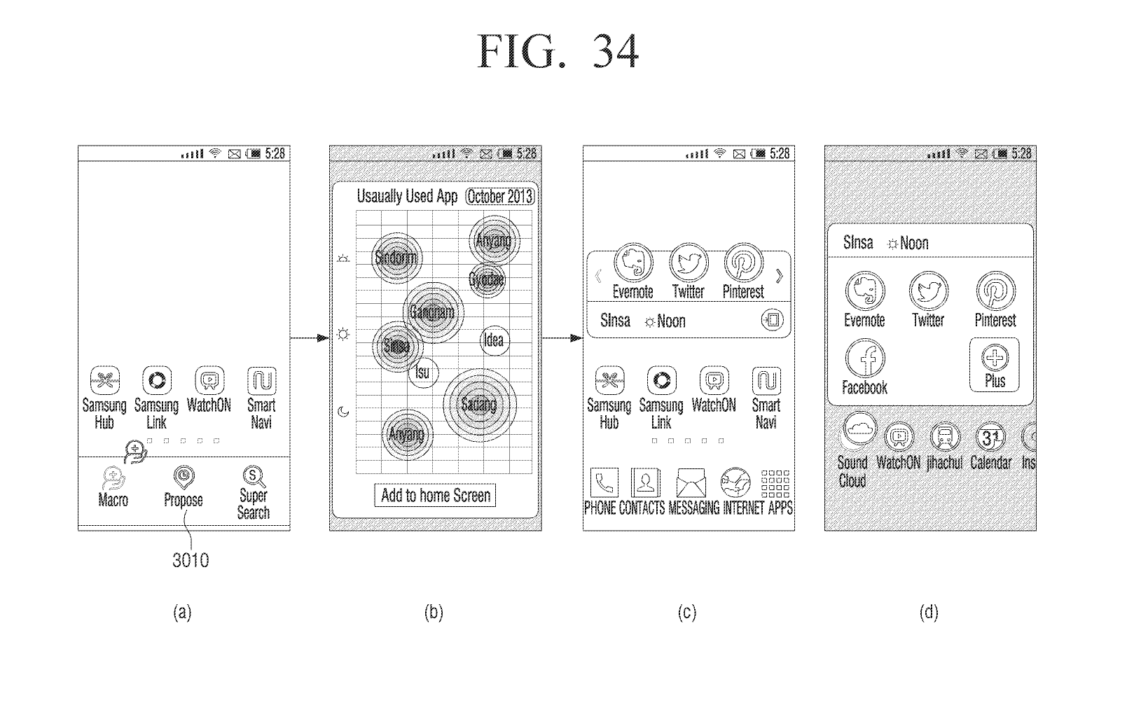

FIG. 34 is a view explaining a process of creating a propose icon in a home screen according to an embodiment of the present disclosure.

The user may complete a setup operation using an execution key 3010 configured to create the propose icon in a home screen as illustrated in element (a) of FIG. 34 through a process similar to the process of FIGS. 32A to 32C. Thus, the image display apparatus 100 of FIG. 1 may perform clustering on stay places of the user according to time and visualize the stay places of the users, and the image display apparatus 100 may recommend and provide frequently used applications according to the context of the user in entering of a corresponding map. For example, the image display apparatus 100 may create a propose widget through a menu as illustrated in element (b) of FIG. 34. The log map may generally display places in which a stay time is relatively long according to time, and manage the recommended applications according to the cluster.

Thus, in response to the user being stay in the same places at different time zones, the recommended applications may be different. For example, in response to the user being in Anyang in the morning, applications for weather, a bus, and news may be recommended, and in response to the user being in Anyang in the evening, applications for a list, a video, and an alarm may be recommended. For example, in response to the user entering a corresponding area, an Apps icon as illustrated in element (c) of FIG. 34 is displayed in the home screen based on log. The user may change the App to be displayed as illustrated in element (d) of FIG. 34 in any degree.

A mobile terminal such as a smart phone may perform clustering on a place and time of the user every day (or every week/every month), store applications executed in cluster units, and recommend the corresponding applications in response to entering the same cluster. The user may check clusters of his/her place and time patterns through a log map, and may designate proposed applications other than auto recommendation in any degree. Further, in an embodiment of the present disclosure, the mobile terminal creates clusters representing contexts on a two-dimensional (2D) matrix through an explicit context, that is, the time and place, and provides the created clusters to the user who represents the clusters visually.

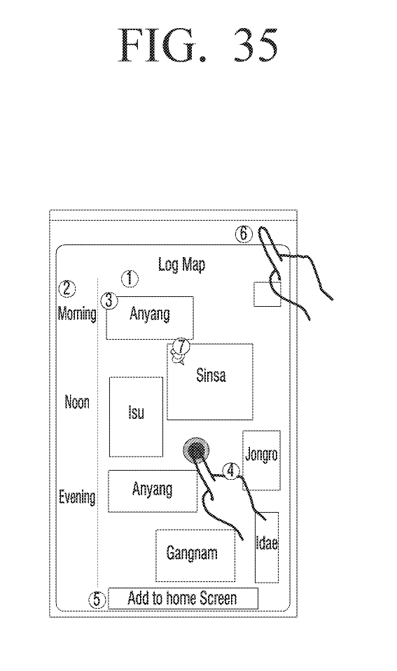

FIG. 35 is a view illustrating a log map illustrated in element (b) of FIG. 34 according to an embodiment of the present disclosure.

Items \textcircled{1} to \textcircled{7} in FIG. 35 may be defined as in the following Table 1.

TABLE 1

| No. | Title | Info |
|---|---|---|
| \textcircled{1} | Title | “Long Map” |
| \textcircled{2} | Time axis | A day is divided into 3 and provided |
| | | as morning, afternoon, evening |
| \textcircled{3} | Group according to place | Display App frequently used in |
| | | corresponding place with popup in |
| | | selection |
| \textcircled{4} | Long Tap Anywhere | Setup to home screen is possible with |
| | | Long Tap anywhere in popup |
| \textcircled{5} | Add to Home Screen | The same function as Long Tap |
| \textcircled{6} | Tap Outside of Popup | Popup is closed. Popup may be also |
| | | closed with hard key “Back” |
| \textcircled{7} | Pin | Display current location of user |

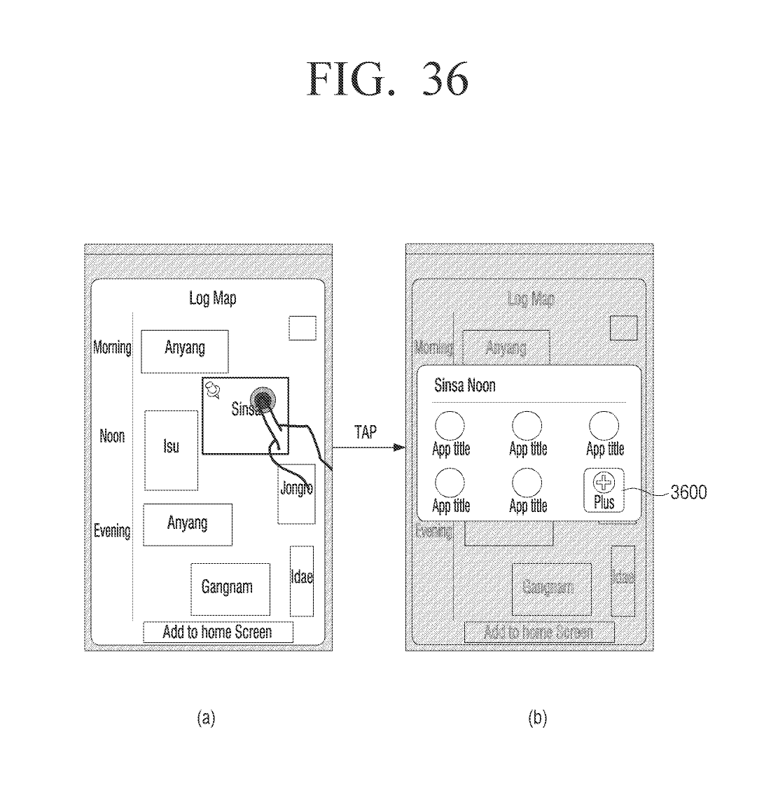

FIG. 36 is a view explaining an edit process of an application list according to an embodiment of the present disclosure.

As illustrated in element (a) of FIG. 36, a user may select a specific place on a log map. Thus, the screen illustrated in element (a) of FIG. 36 may be converted to a screen illustrated in element (b) of FIG. 36. The user may perform an edit process using an Add(+) key 3600 in the screen as illustrated in FIG. 36(b) in response to an application list used by the user being not presented in a corresponding cluster or being to be added to the corresponding cluster.

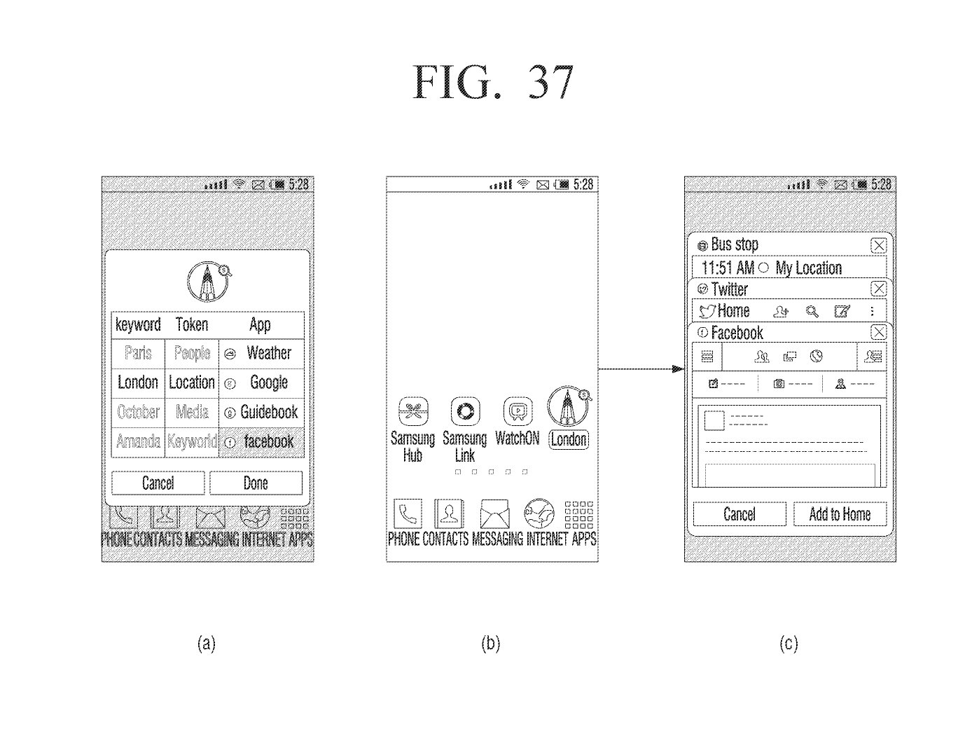

FIG. 37 is a view explaining a process of creating a search icon according to an embodiment of the present disclosure.

Referring to element (a) of FIG. 37, in response to the execution key 3020, as illustrated in FIG. 32B, configured to create the search icon being selected in to home screen as illustrated in FIGS. 30A and 30B by the user, a screen as illustrated in element (a) of FIG. 37 may be displayed. In response to search words corresponding to three categories such as People, Location, and Media being designated through the corresponding screen by the user, items related to applications which receive variables of the corresponding categories are displayed.

In response to a setup process being completed through the displayed items, the created search words may be registered on the home screen as illustrated in element (b) of FIG. 37, and thus the search work may be easily input. The registered search word may be transmitted to one or more target applications, and thus 1:N type connection may be possible as illustrated in element (c) FIG. 37. The search word and the target application may be designated in a package, and thus desired information may be easily fast consumed through the application.

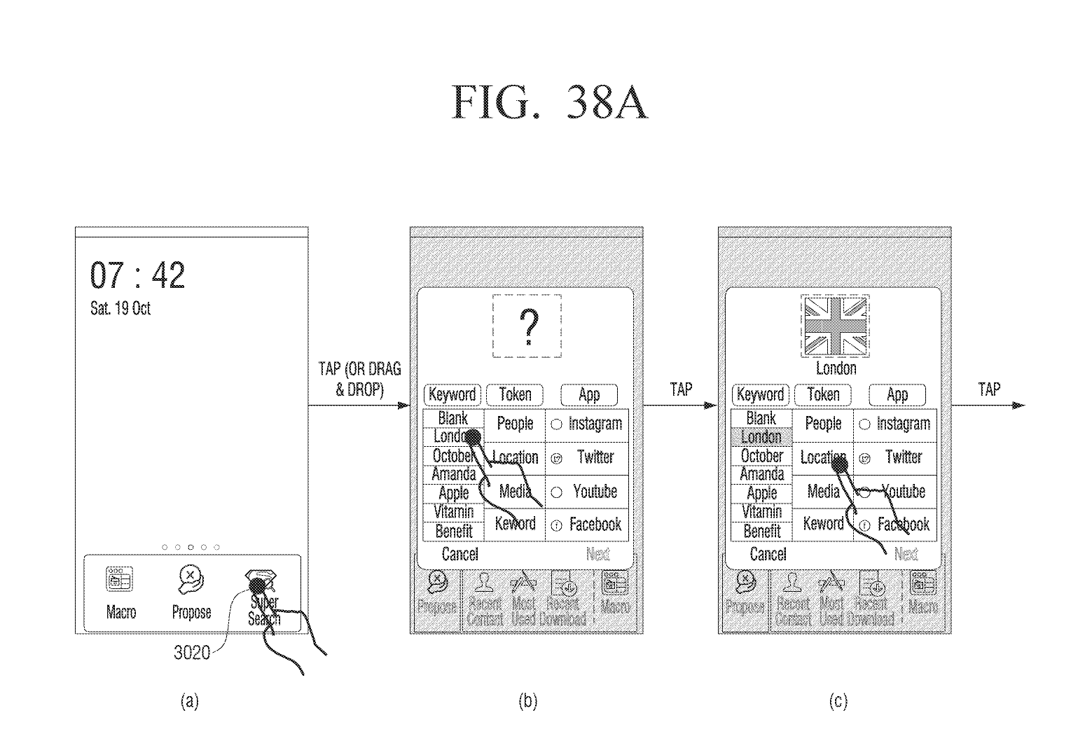

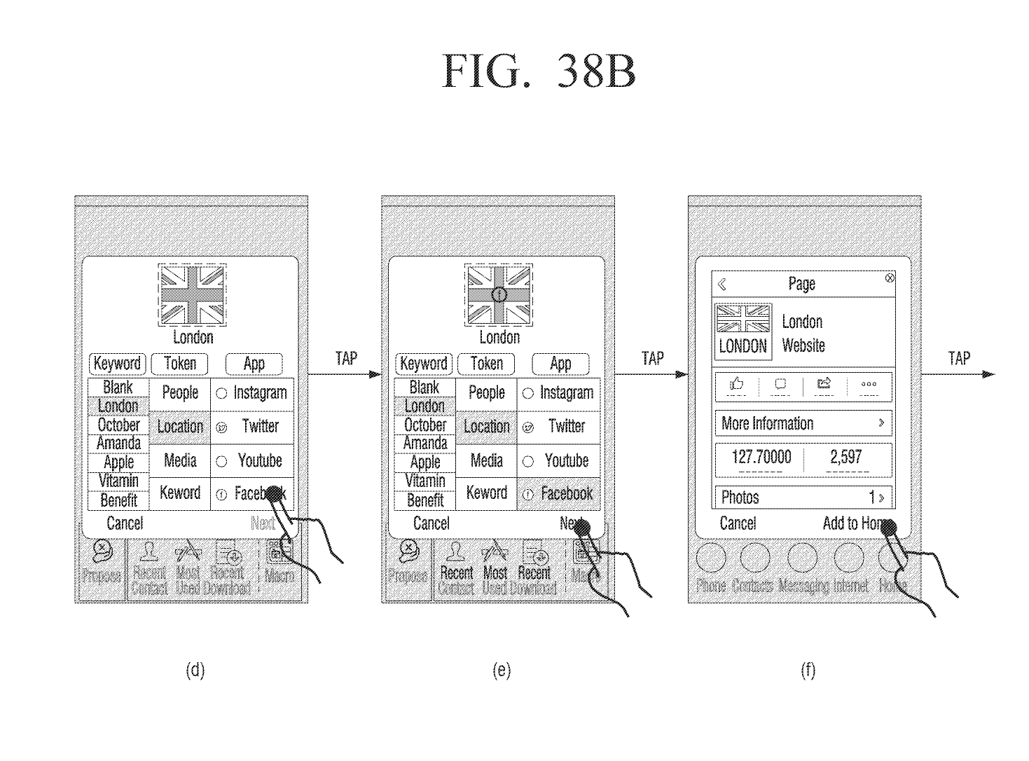

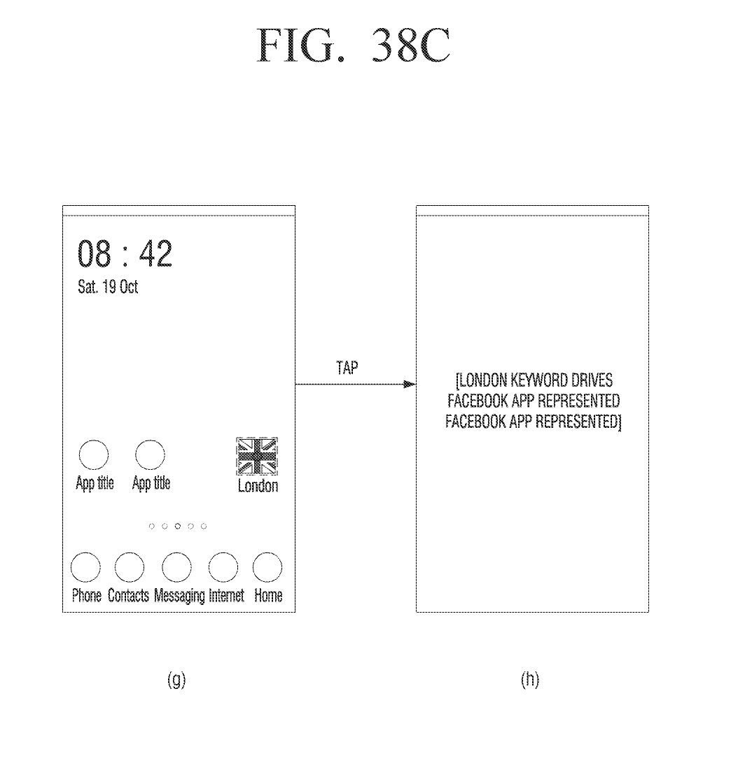

FIGS. 38A, 38B, and 38C are detailed views illustrating a process of creating a search icon of FIG. 37.

Referring to FIG. 38A, a user may select an execution key 3020 configured to generate the search icon in a home screen, and a screen as illustrated in element (b) of FIG. 38A may be displayed. The user may select Keyword of an application to be generated, Token, and App in order, and thus Description allows the keyword of App to be set to be represented in the screen. Keyword reflects values seared in the terminal by the user with log (or log data), and Token is fixed. App may be differently recommended according to Token.

In response to Next being performed after the whole setup is completed as illustrated in element (b) of FIG. 38A to element (e) of FIG. 38B, as illustrated in element (f) of FIG. 38B to element (h) of FIG. 38C, the image display apparatus 100 of FIG. 1 provides search values of App in a preview form based on corresponding Keyword and Token, and then an application is added to the home screen in response to an Add to Home key being selected by the user. In response to the selected application being one, the corresponding keyword may become an icon, and the icon of the connected application may be provided with a badge. In response to the corresponding icon being selected, a screen may be provided in a type as illustrated in element (c) of FIG. 37. Token is a category which defines an attribute of a keyword, and a type of an application which receives the keyword is determined according to the type of Token. For example, People may be contacts, SNS, or the like.

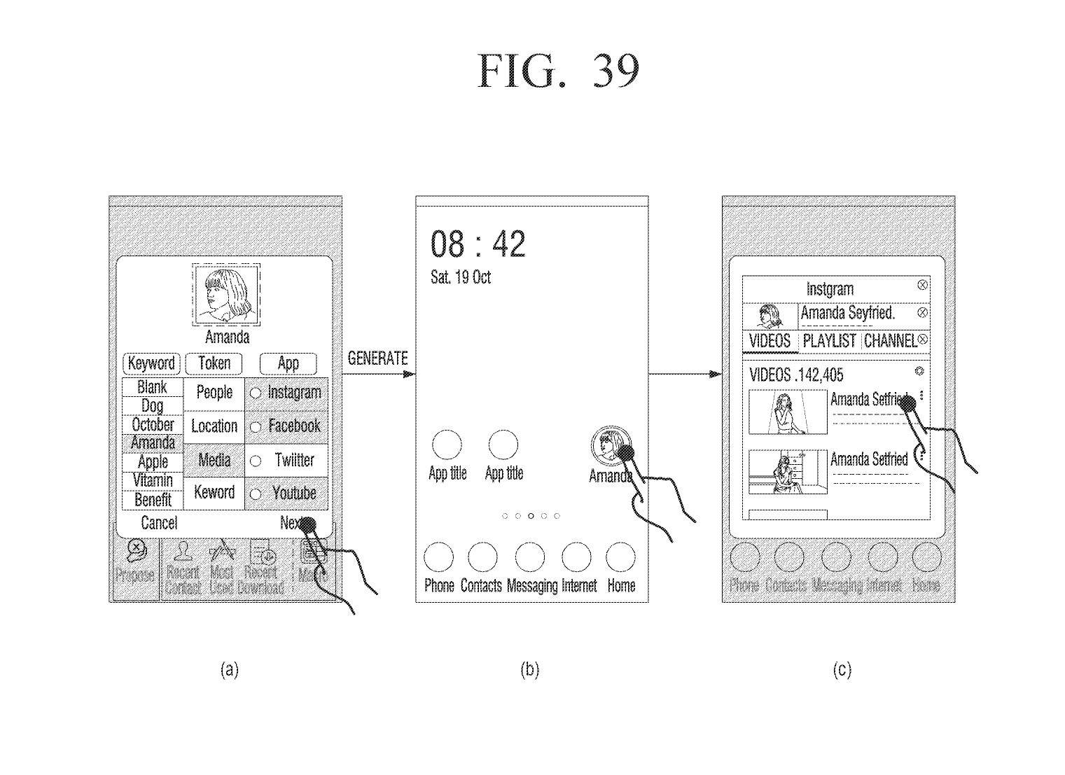

FIG. 39 is a view explaining a searching result in response to keywords being the same and attributes being different according to an embodiment of the present disclosure.

As illustrated in element (a) FIG. 39, even though a keyword is the same as Amanda, the search keyword is searched for in the contacts or Facebook™ in response to an attribute being set to People by the user, but the keyword is transmitted to different types of applications in response to the attribute being set to a Media category. The keyword may be brought from a Google™ search word history, or may be directly input. Element (a) of FIG. 39 illustrates that the attribute is set to the Media category.

Thus, a corresponding icon may be created in a home screen as illustrated in element (b) of FIG. 39, and in response to the several applications being selected, a cue which is multiply viewed may also be provided. Such a UI may be variously represented according to a configuration of a graphic user interface (GUI). Element (c) of FIG. 39 illustrates a searching result according to the setting of the attribute to the Media category.

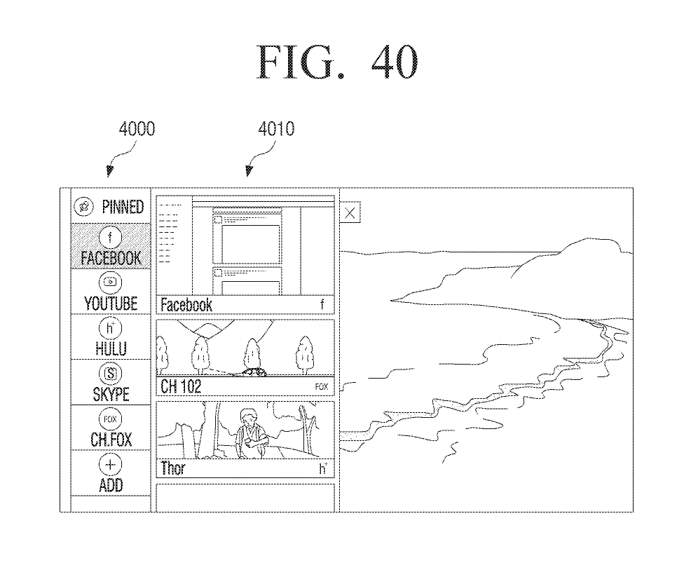

FIG. 40 is a view illustrating an example in which a variable icon is applied to a TV according to an embodiment of the present disclosure.

The contents described with reference to FIGS. 35 to 39 until now may be substantially applied to a TV of FIG. 40 in any degree. In other words, a home screen 4000 of FIG. 40 may include various execution icons, and a dynamic view region 4010 may display items associated with a plurality of applications such as SNS. Therefore, the contents may be changed like the display of the user context-based application, and applied.

Through the above-described configuration, the user may directly select the attribute and function to create an icon changed according to the condition, and may recommend the icon according to the context and easily access to the desired information. The space in the limited home screen may be optimally used.

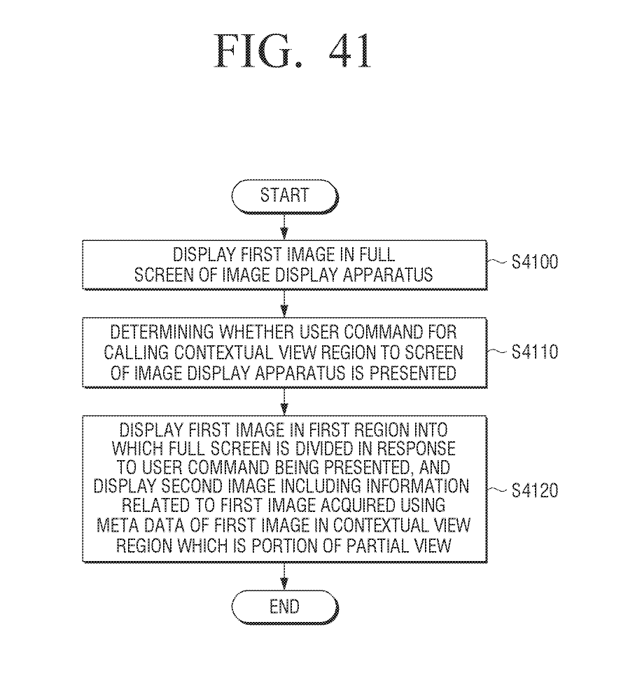

FIG. 41 is a flowchart illustrating a process of driving an image display apparatus according to an embodiment of the present disclosure.

For clarity, referring to FIG. 41 together with FIG. 1, the image display apparatus 100 according to an embodiment of the present disclosure displays a first image such as a broadcasting program in a screen according to the user request at operation S4100.

In response to a user command for requesting related information related to the displayed first image being presented in the state in which the first image, that is, the image of a unit frame is displayed, the image display apparatus provides the related information related to the first image acquired using metadata of the first image to a context view region at operations S4110 and S4120, wherein in operation S4110 it is determined whether a user command for calling a contextual view region to a screen of an image display apparatus is presented, and in operation S4120 the image display apparatus displays a first image in a first region into which a full screen is divided in response to a user command being presented, and displays a second image including information related to the first image acquired using metadata of the first image in the contextual view region, which is a portion of a partial view.

The image display apparatus 100 provides the first image and a second image to partial views so as not to prevent break of watching flow of the user.

The method of obtaining the related information is distinguished from the method of obtaining searched information according to the related art by selecting a specific item in an image displayed in a screen in that the related information displayed in the contextual view region may be automatically provided according to the user command for simply calling the contextual view region.

The method of receiving the related information in the various embodiments of the present disclosure is distinguished from the method of receiving the related information from one information source such as a server using information for a corresponding item, according to the related art, in that the method of the various embodiments of the present disclosure receives the related information from various channels, that is, various information sources using key data among the metadata associated with the first image, and displays the related information.

Further, in response to a user command such as a menu key being presented according to the related art, an EPG is displayed in the screen. However, the display method of the related art is different from the display method of receiving the related information from a plurality of information sources using the metadata in the various embodiments of the present disclosure in that the display method of the related art provides information stored in the inside in a preset format. Further, the display method of the related art is distinguished from the display method in the various embodiments of the present disclosure in that the watching flow of the user is broken.

The method of calling the EPG through the menu key according to the related art is distinguished from the method using the metadata in the various embodiments of the present disclosure in that the method of the related art determines whether or not the signal corresponding to the menu key is a command for calling the EPG, and displays the EPG screen according to the determination result.

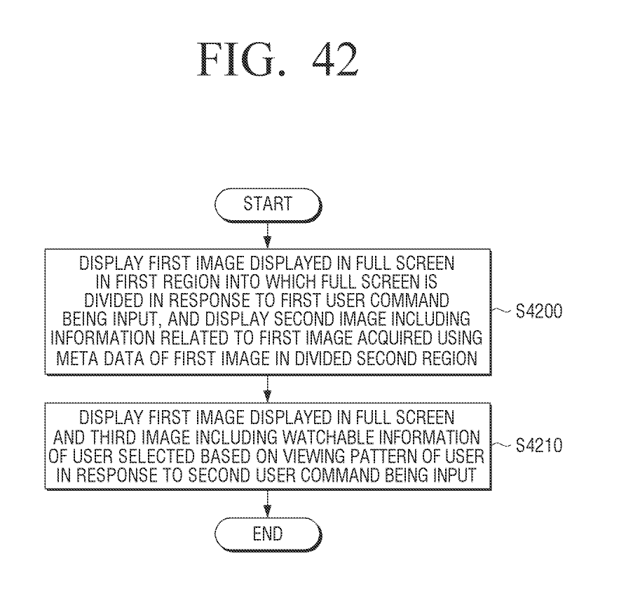

FIG. 42 is a flowchart illustrating an image display method according to an embodiment of the present disclosure.

For clarity, referring to FIG. 42 together with FIG. 1, in response to being determined that a first user command input from the user, the image display apparatus 100, as illustrated in FIG. 1, according to an embodiment of the present disclosure displays a first image displayed in a full screen in a first region into which the full screen is divided, and displays a second image including information, which is related to the first image, and acquired using metadata of the first image, in a second region into which the full screen is divided at operation S4200. The process presupposes that the first image such as a broadcasting program is displayed in the full screen.

In response to a second user command being presented in the state in which the first image is displayed in the full screen, the image display apparatus 100 may display a third image including watchable information of the user selected based on a viewing pattern of the user together with the first image at operation S4210. For example, the third image does not significantly disturb watching of the user, and thus the third image may be displayed to overlap the first image in an edge region of the full screen. In response to the second user command being input at operation S4200, the second image displayed in the partial view may disappear, and the first image may be displayed in the full screen again.

Even though the various embodiments of the present disclosure have described that all configuration components are combined in one or combined in one and operated, the various embodiments of the present disclosure are not limited thereto. That is, one or more components among the configuration components may be selectively combined and operated in the scope of an object of the present disclosure. Further, all configuration components may be implemented with independent hardware, respectively, but partial configuration components or the whole configuration components are selectively combined, and may be implemented with a computer program having a program module which performs the partial functions or the whole functions combined in one or a plurality of hardware. The codes and code segments constituting the computer program may be easily constructed by those skilled in the related art. The computer program may be stored in a non-transitory computer-readable medium and read and executed by the computer, and thus the various embodiments of the present disclosure may be realized.

The non-transitory computer-recordable medium is not a medium configured to temporarily store data such as a register, a cache, or a memory but an apparatus-readable medium configured to semi-permanently store data. Specifically, the above-described programs may be stored in the non-transitory apparatus-readable medium such as a compact disc (CD), a digital versatile disc (DVD), a hard disc, a Blu-ray disc, a universal serial bus (USB), a memory card, or a ROM, and provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of displaying an image, the method comprising:
displaying a first image on a screen of an image display apparatus; and
displaying a second image including information related to the first image on one region of the screen in response to a first user command being input,
wherein the information related to the first image is acquired using a user-based program stored in the image display apparatus in connection with metadata of the first image.

2. The method of claim 1,
wherein the displaying of the first image comprises displaying the first image on a full screen of the image display apparatus,
wherein the displaying of the first image comprises displaying the first image on a first region into which the full screen is divided in response to the first user command being input, and
wherein the displaying of the second image related to the first image on the one region of the screen comprises displaying the second image on a second region into which the full screen is divided.

3. The method of claim 1,
wherein the second image comprises information associated with a plurality of pieces of key data designated among the metadata, and
wherein the information associated with the plurality of pieces of key data is provided differently according to a user based on the user-based program.

4. The method of claim 1, further comprising displaying the first image together with a third image including watchable information of a user selected based on a viewing pattern of the user in response to a second user command being input,
wherein the watchable information includes channeling information related to an auto channeling function which changes the first image to an image based on the viewing pattern.

5. The method of claim 1, further comprising, in response to a third user command being input:
displaying the first image on a divided first region of the screen; and
displaying a fourth image for representing a designated information object in a form of an icon and a fifth image for representing a context and information of a new image screen matching with the icon on a divided second region of the screen.

6. The method of claim 5, wherein the fourth image allows an information object desired by a user among information objects having information-structural depths to be registered in a form of the icon.

7. The method of claim 5, wherein a new fourth image for representing an information object designated by an arbitrary user in an icon form is displayed in response to a user account-related icon being selected in the fourth image.

8. The method of claim 1, further comprising:
changing the first image to an image based on a viewing pattern of a user; and
displaying the changed image in response to an auto channeling function for automatically changing the image based on the viewing pattern of the user being set.

9. The method of claim 1, wherein the first image is analyzed and a result of the analysis is used as the metadata, in response to the metadata being provided from an outside in connection with the first image being not presented.

10. An apparatus for displaying an image, the apparatus comprising:
a display unit configured to display a received first image on a screen; and
a controller configured to control the display unit to display a second image including information related to the first image on one region of the screen in response to a first user command being input,
wherein the information related to the first image is acquired using a user-based program stored in the image display apparatus in connection with metadata of the first image.

11. The apparatus of claim 10, wherein the display unit is further configured to:
display the first image on a full screen of the image display apparatus,
display the first image in a first region into which the full screen is divided; and
display the second image on a second region into which the full screen is divided in response to the first user command being input.

12. The apparatus of claim 10,
wherein the display unit is further configured to display information associated with a plurality of pieces of key data designated among the metadata in the second image, and
wherein the information associated with the plurality of pieces of key data is provided differently according to a user based on the user-based program.

13. The apparatus of claim 10,
wherein the display unit is further configured to display the first image together with a third image including watchable information of a user selected based on a viewing pattern of the user in response to a second user command being input, and
wherein the watchable information includes channeling information related to an auto channeling function which changes the first image to an image based on the viewing pattern.

14. The apparatus of claim 10, wherein, in response to a third user command being input, the display unit is further configured to:
display the first image on a divided first region of the screen; and
display a fourth image for representing a designated information object in a form of an icon and a fifth image for representing a context and information of a new image screen matching with an icon on a divided second region of the screen.

15. The apparatus of claim 14, wherein the fourth image allows an information object desired by a user among information objects having information-structural depths to be registered in a form of the icon.

16. The apparatus of claim 14, wherein the display unit is further configured to display a new fourth image for representing an information object designated by an arbitrary user in an icon form in response to a user account-related icon being selected in the fourth image.

17. The apparatus of claim 10, wherein the controller is further configured to change the first image to an image based on a viewing pattern of a user in response to an auto channeling function for automatically changing the image based on the viewing pattern of the user being set.

18. The apparatus of claim 10, wherein the controller is further configured to analyze the first image and to use a result of the analysis as the metadata, in response to the metadata being provided from an outside in connection with the first image being not presented.

19. A non-transitory computer-readable storage medium storing instructions, that, when executed, cause at least one processor to perform an image display method comprising:
displaying a second image including information related to a first image displayed on a screen on one region of the screen in response to a first user command being input; and
displaying the first image and a third image including watchable information of a user selected based on a viewing pattern of the user in response to a second user command being input,
wherein the information related to the first image is acquired using a user-based program stored in an image display apparatus in connection with metadata of the first image.

20. The non-transitory computer-readable storage medium of claim 19,
wherein the watchable information includes channeling information related to an auto channeling function which changes the first image to an image based on the viewing pattern, and
wherein, in response to a third user command being input, the image display method further comprises:
displaying the first image on a divided first region of the screen; and
displaying a fourth image for representing a designated information object in a form of an icon and a fifth image for representing a context and information of a new image screen matching with the icon on a divided second region of the screen.
